(19) United States
(12) Patent Application Publication
(10) Pub. No.: US 2026/0303725 A1
(43) Pub. Date: Oct. 1, 2026

(54) VOICE COMMUNICATION SYSTEM WITH AUTOMATED PROVISIONING

(71) Applicant: IPC Systems, Inc., New York, NY (US)

(72) Inventors: Craig Benedict Helfer, JR., East Hanover, NJ (US); Jérôme Olivier Loïc Jurbert, Fublaines (FR); Robert Coole, Bushey (GB)

(21) Appl. No.: 19/578,263

(22) Filed: Mar. 25, 2026

Related U.S. Application Data
(60) Provisional application No. 63/777,057, filed on Mar. 25, 2025.

(51) Int. Cl. H04M 3/50; H04L 65/1104; H04M 3/42

(52) U.S. Cl. CPC H04M 3/50; H04L 65/1104; H04M 3/42008

(57) ABSTRACT

A voice communication system provides automated user provisioning and connectivity across a unified network. A central controller manages a consolidated database of users across multiple local communications systems and automatically assigns unique global identifiers to each user. Edge agents collect user information from local systems via communication system interfaces and coordinate with the central controller to provision extensions, buttons, and communication paths. The system supports multiple service types including public numbers, private numbers, virtual speed-dial links, and private lines. Users control visibility and accessibility through configurable privacy settings. The system enables users to search a global directory, establish connections through acceptance workflows, and provision private communication lines with encrypted voice communications.

### CROSS REFERENCE TO RELATED APPLICATIONS

This application claims priority to, and the benefit of, U.S. Provisional Patent Application Serial No. 63/777,057, filed Mar. 25, 2025, which is hereby incorporated by reference in its entirety.

### TECHNICAL FIELD

Example embodiments described herein relate generally to voice communications systems, and more particularly to automated provisioning of voice connections with user-controlled privacy settings and encrypted communications.

### BACKGROUND

Voice communications systems using private wire connections have traditionally relied on manual processes for establishing links between organizations. Many systems require users to submit requests through email or order systems, involving extensive human validation and configuration across multiple internal systems. This process is often slow, taking days or weeks to complete.

A technical problem with known systems is the lack of a unified global directory, requiring contact information to be maintained separately in multiple databases, leading to redundancy and management challenges. Additionally, traditional private wire connections typically operate at a business-to-business level, making it difficult to verify and authenticate individual users—a growing concern for compliance and security.

Many existing voice communication platforms provide only limited automation and still require manual intervention for configuring connections, managing directories, controlling access, and ensuring compliance. Organizations need a more efficient and secure approach that enables instant connectivity while maintaining robust user authentication, access controls, and encryption to meet compliance requirements.

Implementing a more automated and secure communications system presents several technical problems. These include integrating disparate communication platforms, establishing a unified global directory without compromising security, and ensuring seamless interoperability between organizations with different infrastructure and compliance requirements.

### SUMMARY

The example embodiments described herein meet the above-identified needs by providing a voice communications system with automated user provisioning and substantially instant connectivity through a unified global network. The system includes a central controller configured to manage a consolidated database of users across multiple communications systems, automatically assigning unique global identifiers to each user.

The system enables self-service automation by allowing users to search a global directory, establish connections with other users through acceptance workflows, and substantially instantly provision private communication lines. Users maintain control over their visibility and accessibility through detailed privacy settings and connection management capabilities.

In an example embodiment, a core controller orchestrates the automated provisioning workflow between portal interfaces, edge agents, and voice network components. Edge agents collect user information from local systems and coordinate with the core controller to provision extensions, buttons, and communication paths.

The architecture employs a multi-layered security approach with encrypted communications, certificate-based authentication, and granular access controls. Users can block unwanted communications while maintaining private connections with approved counterparties. The system validates user identities and permissions at both the individual and organizational levels.

In some embodiments, a method for managing voice communications across a plurality of communication systems involves collecting user information from a plurality of communication systems, transmitting the user information to a central controller, adding users to a community maintained in a consolidated database based on the user information, automatically assigning unique identifiers to each user wherein each unique identifier comprises an application prefix, a system identifier, a number type indicator, and a user number, provisioning extensions in the plurality of communication systems corresponding to the user numbers, and provisioning resource buttons in user interfaces to enable users to receive incoming calls on the extensions. In an example implementation, the collecting step is performed by one or more edge agents, the transmitting step is performed by the one or more edge agents, the adding step is performed by the central controller, the automatically assigning step is performed by the central controller, the provisioning extensions step is performed by the one or more edge agents, and the provisioning resource buttons step is performed by the one or more edge agents.

In some embodiments, the system extends beyond private line provisioning to provide an identity-driven communication platform that manages multiple connection types across a global user network. The connection model may include not only dedicated private lines, but also public directory listings, temporary connection links, dynamic routing paths, and peer-to-peer connections. The system manages user identity, connection permissions, and communication routing, with private line provisioning representing one of multiple connection services offered through the unified platform. This architecture allows users to establish, manage, and control various types of voice connections through a single integrated interface, with the system dynamically determining connection methods based on user preferences, permissions, availability, and context.

In some embodiments, the method further comprises receiving a search request from a first user to search the community, querying the consolidated database for contact records matching search criteria in the search request, returning search results filtered based on privacy settings, and receiving a selection of a second user from the search results. In an example implementation, these steps are performed by the central controller.

In some embodiments, the method further comprises receiving a call initiation request from the first user to call the second user, transmitting a computer telephony integration call request to an edge agent associated with the first user, generating an outgoing call using a unique identifier assigned to the second user, and establishing a voice connection between the first user and the second user. In an example implementation, the receiving and transmitting steps are performed by the central controller, and the generating step is performed by a communication system associated with the first user.

In some embodiments, the method further comprises monitoring presence information indicating whether users are logged into turrets, determining turret types for logged-in users, transmitting real-time presence updates to the central controller, and distributing the presence updates to client application components for display via presence indicators. In an example implementation, the monitoring, determining, and transmitting steps are performed by the one or more edge agents, and the distributing step is performed by the central controller.

In some embodiments, the presence indicators display one or more of whether a user is logged into a turret, a type of turret the user is logged into, and whether the user is currently busy on an active call.

In some embodiments, the method further comprises receiving visibility settings from users wherein each visibility setting defines access restrictions for assigned numbers, enforcing privacy policies based on the visibility settings, publishing public numbers in a global community directory, and excluding private numbers from the global community directory. In an example implementation, the receiving and enforcing steps are performed by the central controller.

In some embodiments, enforcing privacy policies comprises applying default permit behavior for public numbers such that all calls are permitted unless a blocking rule is applied and applying default deny behavior for private numbers such that all calls are denied unless a permit rule is applied.

In some embodiments, the method further comprises receiving a blocking rule from a user identifying one or more numbers to block, updating access control lists in the consolidated database, and transmitting the access control lists to communication systems to reject calls from blocked numbers. In an example implementation, these steps are performed by the central controller.

In some embodiments, the method further comprises managing routing rules for a plurality of communication systems, extracting a calling number and a called number from call signaling for an incoming call, querying access control rules associated with the called number, determining whether to permit or deny the incoming call based on the access control rules and the number type indicator, and routing or rejecting the incoming call based on the determination. In an example implementation, the managing step is performed by the central controller, and the extracting, querying, determining, and routing or rejecting steps are performed by one of the communication systems.

In some embodiments, the number type indicator identifies the called number as one of a public number, a private number, or a private line endpoint.

In some embodiments, the method further comprises receiving a private line request from a first user specifying a second user as a counterparty, creating a private line record in the consolidated database indicating a pending state, transmitting an acceptance request to the second user, receiving acceptance of the private line request from the second user, initiating provisioning of the private line in response to the acceptance, generating a unique connection number for the private line, orchestrating provisioning of private line extensions at both endpoints via edge agents, provisioning call screening rules in communication systems to block calls from numbers other than designated counterparty endpoints, receiving provisioning completion notifications from the edge agents and the communication systems, and updating the private line record to indicate the private line is active when all provisioning is complete. In an example implementation, these steps are performed by the central controller.

In some embodiments, the private line record comprises a from-end enterprise identifier, a from-end user identifier, a from-end location, a from-end system identifier, a to-end enterprise identifier, a to-end user identifier, a to-end location, a to-end system identifier, the unique connection number, the status, provisioning state flags, and a request date.

In some embodiments, the method further comprises receiving a deletion request for the private line from one of the first user or the second user, initiating removal of the private line extensions at both endpoints, orchestrating deprovisioning of the private line extensions through the edge agents, receiving completion notifications from the edge agents, and updating the private line record to indicate the private line has been removed. In an example implementation, these steps are performed by the central controller.

In some embodiments, the method further comprises managing license pools associated with employers, assigning licenses to users from the license pools wherein the licenses comprise number licenses authorizing private numbers and line licenses authorizing private lines, receiving a request to provision a private number or a private line for a user, verifying that the user has an available license of the appropriate type, and provisioning the private number or the private line only if the license is available. In an example implementation, the managing, assigning, receiving, and verifying steps are performed by the central controller.

In some embodiments, the method further comprises managing team numbers associated with multiple users who are members of a team, configuring the team numbers to be accessible to all team members, and provisioning extensions and buttons for the team numbers to enable all team members to receive calls on the team numbers. In an example implementation, the managing and configuring steps are performed by the central controller, and the provisioning step is performed by edge agents.

In some embodiments, the method further comprises provisioning virtual speed-dial links comprising dedicated back-to-back numbers configured as dedicated speed-dials between users, configuring communication systems to permit calls between the back-to-back numbers only when originated from counterparty endpoints, and blocking any calls to the dedicated back-to-back numbers from numbers other than the designated counterparties. In an example implementation, the provisioning and configuring steps are performed by the central controller, and the blocking step is performed by the communication systems.

In some embodiments, the method further comprises maintaining local databases storing user information and presence data, detecting connectivity between an edge agent and the central controller being temporarily interrupted, continuing to provide local presence monitoring and service requests using the local database during the temporarily interrupted connectivity, detecting restoration of connectivity to the central controller, and synchronizing with the central controller to update changes that occurred during the temporarily interrupted connectivity. In an example implementation, these steps are performed by the one or more edge agents.

In some embodiments, the method further comprises implementing call admission control by limiting concurrent calls to a particular number based on configured maximum concurrent call limits, receiving an incoming call to a called number, querying a current number of active calls for the called number, determining whether the current number of active calls equals or exceeds the maximum concurrent call limit, and rejecting the incoming call if the maximum concurrent call limit is reached. In an example implementation, these steps are performed by communication systems.

In some embodiments, a non-transitory computer-readable medium stores instructions that, when executed by one or more processors, cause the one or more processors to perform operations comprising collecting user information from a plurality of communication systems via one or more edge agents, receiving the user information at a central controller from the one or more edge agents, adding users to a community maintained in a consolidated database based on the user information, automatically assigning unique identifiers to each user wherein each unique identifier comprises an application prefix, a system identifier, a number type indicator, and a user number, provisioning extensions in the plurality of communication systems corresponding to the user numbers via the one or more edge agents, and provisioning resource buttons in user interfaces to enable users to receive incoming calls on the extensions via the one or more edge agents.

In some embodiments, a voice communication system comprises a central controller configured to receive user information from one or more edge agents, add users to a community maintained in a consolidated database based on the user information, automatically assign unique identifiers to each user wherein each unique identifier comprises an application prefix, a system identifier, a number type indicator, and a user number, and coordinate provisioning of extensions and resource buttons via the one or more edge agents. The one or more edge agents are configured to collect user information from a plurality of communication systems via communication system interfaces, transmit the user information to the central controller, provision extensions in the plurality of communication systems corresponding to the user numbers, and provision resource buttons in user interfaces to enable users to receive incoming calls on the extensions. The plurality of communication systems are configured to route communications between users based on the unique identifiers assigned by the central controller.

### BRIEF DESCRIPTION OF THE DRAWINGS

The features and advantages of the example embodiments presented herein will become more apparent from the detailed description set forth below when taken in conjunction with the following drawings.

FIG. 1 illustrates a voice communications system architecture in accordance with an example embodiment.

FIG. 2 illustrates a domain model showing community structure and user connections in accordance with an example embodiment.

FIG. 3 illustrates a domain model showing user networks and directories in accordance with an example embodiment.

FIG. 4 illustrates a domain model showing employer license management in accordance with an example embodiment.

FIG. 5 illustrates a domain model showing number and line abstractions in accordance with an example embodiment.

FIG. 6 illustrates a domain model showing employer deployments and voice identifiers in accordance with an example embodiment.

FIG. 7 depicts a call flow for public number communications in accordance with an example embodiment.

FIG. 8 depicts a call flow for private number communications in accordance with an example embodiment.

FIG. 9 illustrates a deployment architecture in accordance with an example embodiment.

FIG. 10 depicts a community search and call initiation workflow in accordance with an example embodiment.

FIG. 11 depicts a private line provisioning workflow in accordance with an example embodiment.

FIG. 12 depicts a private line state machine with provisioning and unprovisioning workflows in accordance with an example embodiment.

FIG. 13 depicts an alternative private line provisioning workflow for creating private lines with non-community users via employer administrator initiation in accordance with an example embodiment.

FIG. 14 depicts an alternative private line state machine for non-community user private line provisioning and unprovisioning workflows in accordance with an example embodiment.

FIG. 15 depicts computing environment components suitable for implementing example embodiments including processors, memory, instructions, and network interfaces.

### DETAILED DESCRIPTION

The example embodiments presented herein are directed to systems, methods and computer program products for secure voice communication with automated provisioning, which are now described herein in terms of an example voice trading communication platform. This description is not intended to limit the application of the example embodiments presented herein. In fact, after reading the following description, it will be apparent to one skilled in the relevant art(s) how to implement the following example embodiments in alternative embodiments involving any secure voice communication system with automated user provisioning and encrypted connections.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein.

The terminology used herein is for the purpose of describing particular examples only and is not intended to be limiting. As used herein, the singular forms "a", "an" and "the" are intended to include the plural forms as well, unless the context clearly indicates otherwise.

Illustrative examples of the disclosure are described below. In the interest of clarity, not all features of an actual implementation are described in this specification. It will of course be appreciated that in the development of any such actual example, numerous implementation-specific decisions are made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

### System Architecture Overview

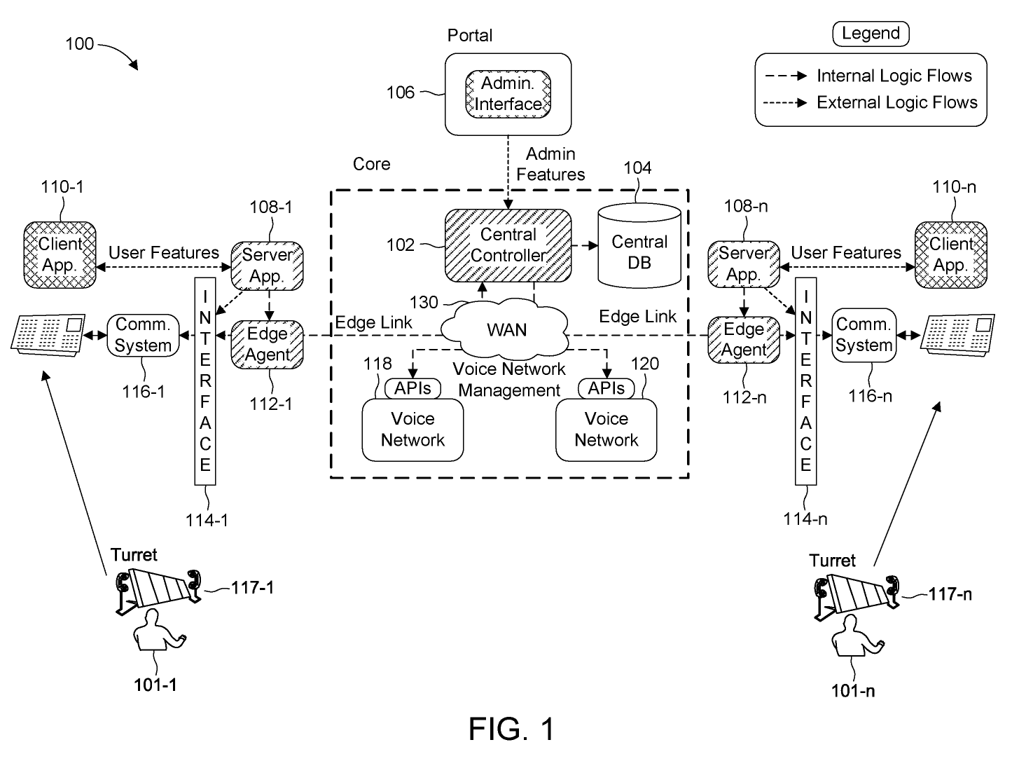

FIG. 1 illustrates an example secure voice communication system 100 in accordance with an example embodiment of the disclosure. The system 100 includes a central controller 102, a central database 104, an administration interface 106 providing administrative features, server application components 108-1, ... , 108-n (individually and collectively server application component(s) 108) providing user features, client application components 110-1 and 110-n (individually and collectively client application component(s) 110), one or more edge agents 112-1, ... , 112-n (individually and collectively edge agent(s) 112), one or more communication system interfaces 114-1, ... , 114-n (individually and collectively communication system interface(s) 114), a plurality of communications systems 116-1, ... , 116-n (individually and collectively communication system(s) 116), a first voice network 118 and a second voice network 120, a plurality of communication turrets 117-1, ... , 117-n (individually and collectively turret(s) 117) for a plurality of users 101-1, ... , 101-n (individually and collectively user(s) 101) to communicate, and a wide area network 130.

In some embodiments, communications system 116 is a trading communications system that represents a specialized switching infrastructure tailored to grant a relatively small number of users access to a vast array of external lines. This system offers an array of advanced communication functionalities, including hoot-n-holler, push-to-talk, intercom, video capabilities, large-scale conferencing, and private wires. Private wires refer to dedicated, point-to-point communication lines that offer reliable, low-latency connectivity between counterparties, often used for high-priority or mission-critical conversations in trading environments. A turret device, also referred to simply as a "turret," serves as the component allowing a user 101 to manage multiple dedicated and active communication lines, including private wires, facilitating simultaneous communications with multiple parties. Turret devices 117 incorporate, in some embodiments, dual handsets, multichannel speaker modules, and support for several communication lines.

A trading turret device 117 is implemented, in some embodiments, either in dedicated hardware, termed a "hard" turret, or in software, known as a "soft" turret. A hard turret typically manifests as a phone-like desktop device equipped with multiple handsets, speakers, and buttons. Conversely, a soft turret exists as a software application that operates on a trader's desktop personal computer (PC) or mobile devices like smartphones. Control of a soft-turret application occurs through the native control interface provided by the computer, including touch screens, styluses, click wheels, or mouse and keyboard inputs. In addition to displaying a graphical representation of the turret on the PC screen, the soft-turret application is configured, in some embodiments, to offer voice and presence features. A soft turret is implemented, in some embodiments, by a combination of a PC or mobile device and connected hardware components such as one or more handsets, speakers, and buttons, providing flexibility in its configuration and usage.

The central controller 102 manages a consolidated database 104 of contact records across a plurality of local communications systems accessible via the communication system interfaces 114. A contact record comprises user information associated with a user in the community. In an example embodiment, a contact record includes: a first name, a last name, a login name, an email address, a user identifier from a local communication system, an enterprise identifier, a last update date, a unique user identifier assigned by the central controller 102, and one or more assigned numbers including at least a public number. The contact record is configured, in some embodiments, to include additional information such as: employer affiliation, primary site association, privacy settings, connection relationships with other users, directory memberships, and presence status.

In some embodiments, the system architecture may be implemented as a distributed control system rather than a single centralized controller. The control functionality may be distributed across multiple control modules, edge components, regional servers, or peer nodes that coordinate through inter-module communication protocols. For example, user authentication functions may reside in one control module, connection routing logic in another module, and licensing verification in yet another module, with these modules operating independently or in coordinated fashion. The system may employ a hybrid architecture combining core control services with edge processing capabilities, allowing certain functions (such as presence updates, local routing decisions, or connection establishment) to occur at edge nodes while maintaining centralized coordination for global directory services, user identity management, or cross-region connection requests. Load balancing, redundancy, and regional optimization may be achieved through distributing control functions across multiple geographic locations or service instances. The term "control system" or "controller" as used herein encompasses both centralized controller implementations and such distributed or hybrid control architectures.

The central controller 102 is configured to automatically assign unique global identifiers to each contact record. In an example embodiment, the unique global identifiers include an application prefix, a system identifier, and a unique user number. In one example, a unique global identifier has the format 888-001-12345-1-1122334455, where 888 represents an outgoing call prefix, 001 represents the application prefix, 12345 represents the system identifier, 1 represents a number type, and 1122334455 represents the unique user number.

Edge agents 112 are configured to collect contact records from local communications systems via the communication system interfaces 114 and transmit the contact records to the central controller 102. In an example embodiment, edge agents 112 collect contact records via application programming interfaces (APIs) provided by the communication system interfaces 114. The edge agents 112 are deployed at edge locations proximate to the local communications systems to reduce latency and provide local resiliency.

The central controller 102 is further configured to receive, via one or more input devices, a search request to establish one or more connections corresponding to two or more contact records managed by the consolidated database 104, and establish the one or more connections using a provisioning workflow that, when executed by the central controller 102, causes the central controller 102 to perform the provisioning based on the search request.

### Central Controller Responsibilities

The central controller 102 is configured to manage the central database 104 and orchestrate workflows between the administration interface 106, edge agents 112, server application components 108, and communications systems 116. The central controller 102 manages a community of users 101, wherein the community comprises users associated with a plurality of local communications systems accessible via the communication system interfaces 114. The central controller 102 consolidates user information from multiple local communications systems to build a unified community directory.

The central controller 102 is further configured to manage one or more of the following: user networks, connections between users, directories for organizing contacts, numbers assigned to users, private lines between users, user profiles and settings, and access control lists. The central controller 102 provides administrative features accessible via the administration interface 106 and user features accessible via the client application components 110.

The central controller 102 manages service licenses based on input provided via the administration interface 106. The central controller 102 is configured to centralize user presence information received from the edge agents 112 and distribute presence updates to the client application components 110. In some embodiments, the central controller 102 provides an access point for edge agents 112 via secure connections. In an example implementation, the secure connections comprise WebSocket Secure (WSS) protocol connections.

### Edge Agent Responsibilities

The edge agents 112 are configured to asynchronously ingest user metadata from disparate local communication nodes via communication system interfaces 114 which are specialized for this purpose. In an exemplary embodiment, the communication system interface 114 functions as a unified middleware abstraction layer, providing standardized RESTful or SOAP-based API access to the underlying telephony and messaging protocols of the local systems. These edge agents 112 execute periodic synchronization of schema-mapped user objects to the central controller 102, facilitating the automated population and reconciliation of the global community directory.

The edge agents 112 are configured to manage local databases for efficiency and local resiliency. The local databases store user information, presence data, and configuration information enabling the edge agents 112 to continue limited operations if connectivity to the central controller 102 is temporarily interrupted. When connectivity is restored, the edge agent 112 synchronizes with the central controller 102 to update any changes that occurred during the interruption.

In some embodiments, the edge agents 112 are configured to manage user extensions and favorites in the local communications systems via the communication system interfaces 114 to allow users 101 to call each other using unique global identifiers. The edge agents 112 provision extensions corresponding to numbers assigned to users 101 by the central controller 102. The edge agents 112 provision resource buttons in user favorites to enable users to receive incoming calls on assigned numbers. In this context, a “button” refers to a user-selectable interface element that provides direct access to a specific communication resource, such as a phone number or line appearance. In some implementations, these buttons are implemented as physical keys on a hardware device (for example, programmable line keys on a turret device) or as soft buttons displayed within a graphical user interface, such as on a desktop application, web client, or mobile app.

In some embodiments, a resource button is associated with a particular assigned number and, when activated or monitored, allows the user to answer incoming calls directed to that number. The edge agents 112 automatically provision and configure these buttons within the user’s favorites or similar interface area so that the assigned numbers appear as readily accessible, clearly identified controls.

In some embodiments, the edge agents 112 are configured to provide an access point and proxy for the client application components 110, enabling requests and notifications to be communicated between the client application components 110 and the central controller 102. The edge agents 112 refresh user presence information by monitoring whether users 101 are logged into turrets 117, determining which type of turret each user 101 is logged into, and detecting when users 101 log out. In some embodiments, the edge agents 112 refresh user presence information by monitoring any one or combination of (i) whether users 101 are logged into turrets 117, (ii) determining which type of turret each user 101 is logged into, and (iii) detecting when users 101 log out.

In some embodiments, the edge agents 112 are configured to audit local communication system configurations via the communication system interfaces 114 to verify that extensions corresponding to assigned numbers maintain proper settings. In an example embodiment, the edge agents 112 verify that extensions maintain a maximum number of appearances at a specified value, verify that associated buttons are not removed or duplicated, and verify that extensions are only used for authorized calls based on call history analysis.

### Unique Global Identifier Structure

The unique global identifiers assigned by the central controller 102 comprise multiple components that enable routing and identification across the system 100. The unique global identifier includes an outgoing call prefix comprising three digits. In an example embodiment, the outgoing call prefix is 888, selected to avoid interference with local routing plans in the local communications systems.

The unique global identifier includes an application prefix comprising three digits that separates call domains. In an example embodiment, the application prefix is 001. The unique global identifier includes a system identifier comprising five digits. In an example embodiment, the system identifier corresponds to a voice network identifier assigned to a local communication system associated with the user 101. The system identifier enables the communications systems 116 to route calls to the appropriate local communication system.

The unique global identifier includes a number type indicator comprising one digit that identifies the type of number. In an example embodiment, the number type indicator is 1 for public numbers, 2 for private numbers, and 3 for private line endpoints. The number type indicator simplifies access control list management by enabling rules to be applied based on number type.

The unique global identifier includes a user number comprising ten digits that uniquely identifies the number within the system 100. A single user 101 is configured, in some embodiments, to have multiple numbers including one public number, zero or more private numbers, and zero or more private line endpoints.

In some embodiments, the globally unique identifier need not follow the specific number format described above (e.g., 888-001-12345-1-1122334455), but may instead comprise alternative identifier structures that ensure global uniqueness while providing user identity and connection routing information. For example, the unique identifier may be a Uniform Resource Identifier (URI) such as "platform://user@domain/line," an alphanumeric token such as "SYS-USER12345-LINE001," a cryptographic hash or public key identifier, a UUID (Universally Unique Identifier) following standard formats, or any other globally unique identifier format that enables the system to resolve user identity and establish connections. The identifier may embed user identity information, connection type information, organization or domain information, and routing hints in various formats and structures. The system maintains mapping tables or directory services that associate these various identifier formats with user accounts, connection endpoints, and routing information. Users may have multiple identifier types simultaneously, with the system translating between formats as needed for directory lookup, connection establishment, or interoperability with external systems. The structured number format represents one preferred embodiment optimized for voice communication contexts, but the broader platform supports any globally unique identifier scheme that enables user identity resolution and connection management.

### Community and User Network Structure

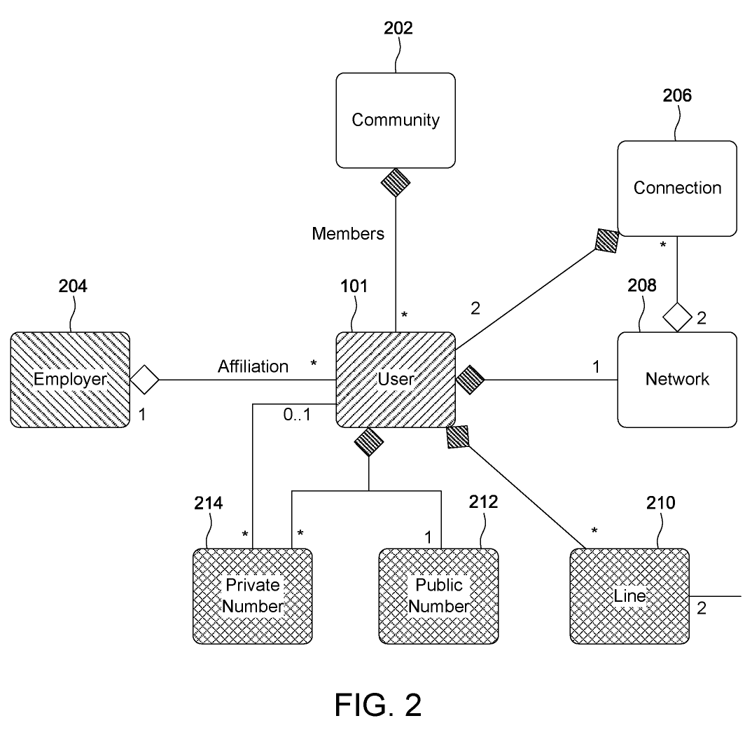

FIG. 2 illustrates a domain model showing community structure and user connections in accordance with an example embodiment. As shown in FIG. 2, the domain model shows relationships between a community 202, users 101, employers 204, and associated communication elements. The model illustrates data structures and relationships that enable the system 100 (shown in FIG. 1) to manage users, connections, and communication services. In FIG. 2, the composition relationship, represented by a filled diamond, indicates that one entity is an integral part of another and is owned by it, while the aggregation relationship, represented by a white diamond, indicates that one entity is composed of multiple entities that can exist independently.

The community 202 represents a collective group of users participating in the system. As indicated by the filled diamond on the community 202 side and the asterisk * cardinality at the user 101 side, the community maintains a composition relationship with its members, meaning the users are integral components of the community structure. Conversely, an employer 204 has an aggregation relationship with a user 101, represented by a white diamond at the employer 204 side. This relationship is defined by a cardinality of 1 at the employer 204 side and an asterisk * cardinality at the user 101 side, indicating that an employer is configured to have multiple affiliated users.

Each user 101 serves as the central hub for their own network and communication endpoints. As shown in FIG. 2, a user 101 has a composition relationship with a network 208, indicated by the filled diamond at the user 101 side of the relationship line. The cardinality of 1 at the network 208 side specifies that the user is configured to organize one network. The network 208, in turn, has an aggregation relationship (white diamond) with a connection 206, which associates two users (indicated by the cardinality of 2 at the user 101 side). This demonstrates that the network organizes connections while the connections themselves remain independent structures.

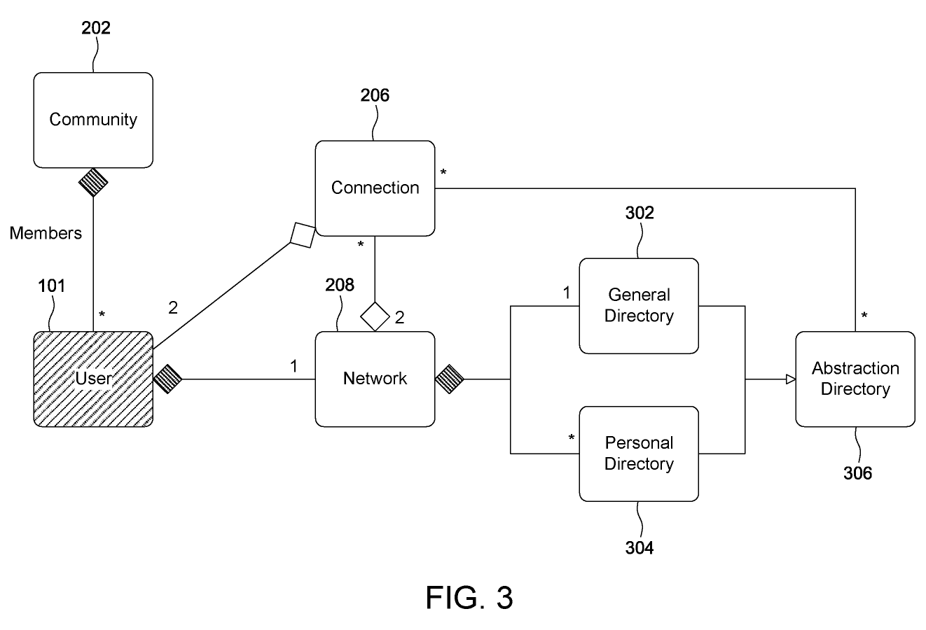

The user 101 maintains a composition relationship with their assigned communication endpoints, as indicated by the filled diamonds at the user 101 side leading to the public number 212, private numbers 214, and lines 210. Each user 101 is assigned one public number 212, as indicated by the cardinality of 1. A user 101 is further configured to have zero or one private number 214, as indicated by the 0..1 cardinality marker. Additionally, a user 101 may be assigned zero or more lines 210, as indicated by the asterisk * cardinality marker. Each line 210 represents an endpoint in a private wire connection that associates two line endpoints, as indicated by the cardinality of 2. The network 208 organizes these connections 206 to populate a general directory 302 (shown in FIG. 3) and a personal directory 304 (shown in FIG. 3), enabling the user to optimize workflow and classify connected counterparties.

### Directory Management

FIG. 3 illustrates a domain model showing user networks and directories in accordance with an example embodiment. The network and directory relationships are managed within the secure voice communication system 100. As illustrated, each user 101 is associated with a network 208 that serves as a personalized container for their communication relationships, directory structures, and connectivity settings. As introduced in FIG. 2, the user 101 maintains a composition relationship with the network 208—indicated by the filled diamond and a cardinality of 1—signifying that the network 208 is an integral, user-specific data structure. This network 208 enables the user 101 to classify connected users and optimize communication workflows across the community 202.

The network 208 comprises a plurality of directories used to organize and filter the global user base. In an example embodiment, the network 208 maintains a composition relationship with both a general directory 302 and an abstraction directory 306. The general directory 302 functions as a comprehensive list containing all users 101 with whom the primary user has established a connection 206. As shown by the cardinality of 2 at the user 101 side of the connection 206, each connection represents a discrete point-to-point relational entity between two specific participants. The network 208 acts as a logical container that aggregates a plurality of these connections 206 (represented by the asterisk * in FIG. 3), allowing them to be managed and filtered within the various directory structures.

The personal directories 304 are specializations of the abstraction directory 306. As indicated by the asterisk * cardinality, a network 208 is configured to include multiple personal directory 304 instances. These allow the user 101 to organize connections into user-defined categories, such as geographic regions, specific asset classes, or communication frequency. The central controller 102 is configured to enable users 101 to create, rename, and delete these personal directories 304 via the client application components 110.

The central controller 102 maintains a global community directory within the central database 104. In this architecture, the central database 104 acts as the core repository for all contact records, while the general directory 302 and personal directories 304 represent filtered views of this core data. This filtering is constrained by individual privacy settings and established connection 206 relationships. For example, a personal directory 304 is maintained for each user 101 to list private numbers 214 (shown in FIG. 2) that have been explicitly shared with them. Because private numbers 214 are not published in the global community directory, the central controller 102 (shown in FIG. 1) only populates a private number 214 into a user’s personal directory 304 once the owner of that number has granted specific permission.

In some embodiments, the network 208 further incorporates one or more blocked lists. These lists identify specific users 101 or unique global identifiers that are restricted from establishing inbound communications. The central controller 102 enforces these rules by automatically rejecting connection requests or calls from identifiers present on the blocked list without notifying the target user. In team-based embodiments, a plurality of users associated with a shared team number are configured to collectively manage the entries within a shared blocked list.

Additionally, each user 101 is configured with a private lines directory that lists all active lines 210. As shown in FIG. 2, each line 210 associates two endpoints. The central controller 102 maintains this directory to show all private lines where the user is either the "from-end" or the "to-end," enabling the user to monitor status and initiate mission-critical communications.

### Employer Affiliation and License Management

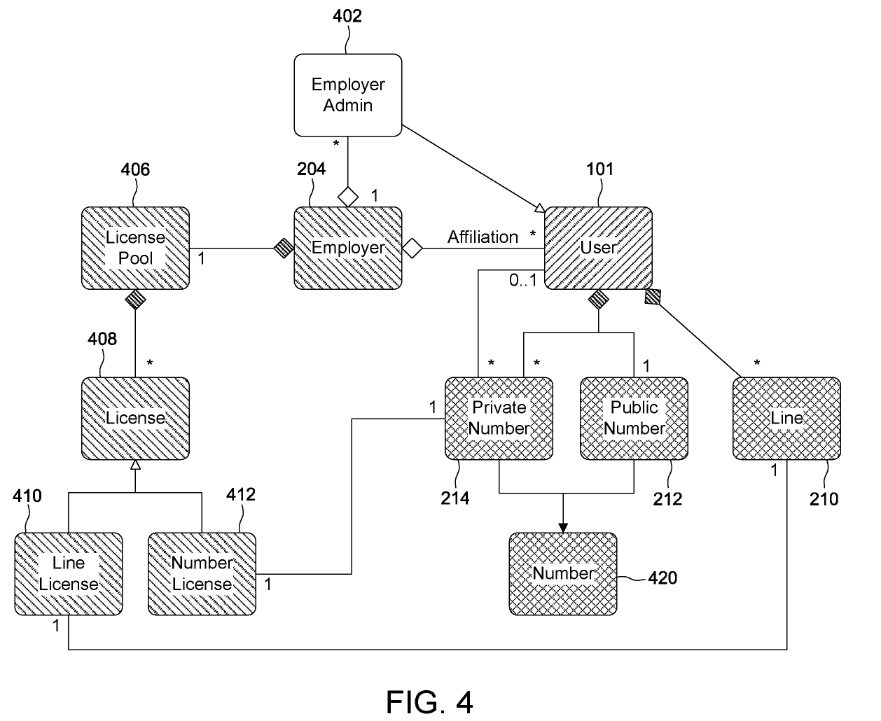

FIG. 4 illustrates a domain model showing employer license management in accordance with an example embodiment. FIG. 4, in this example, depicts employer, license pool, and license relationships within the secure voice communication system 100. As illustrated, the domain model shows how organizational affiliations enable service provisioning and resource allocation through a license-based framework. In this architecture, the central controller 102 acts as the enforcement engine, utilizing the relationships defined in FIG. 4 to gatekeep the allocation of communication resources.

The employer 204 represents a discrete organizational entity or enterprise to which users affiliate. The employer admin 402 manages the employer 204. As illustrated by the asterisk * cardinality on the employer admin 402 side and the 1 cardinality on the employer 204 side, the system is configured to allow a plurality of administrators to manage a single employer entity. These employer admins 402 are authorized to manage license pools, assign licenses to users, and configure employer-level access control policies (ACLs) via the administration interface 106 (shown in FIG. 1).

Each employer 204 owns a license pool 406. As shown in FIG. 4, the relationship between the employer 204 and the license pool 406 is a composition relationship (indicated by the filled diamond at the employer 204 side) with a cardinality of 1:1. This signifies that the license pool is an integral part of the employer entity and its existence is tied to the employer’s lifecycle. The license pool 406 contains multiple licenses, indicated by a filled diamond at the pool side and a cardinality of asterisk * on the license 408 side, meaning the license pool 406 comprises a plurality of individual licenses that it exclusively owns.

The affiliation relationship between user 101 and employer 204 enables the user 101 to use services provided by the system 100. As shown in FIG. 4, the user 101 has an aggregation relationship (indicated by the white diamond at the employer 204 side) with the employer 204. The cardinality of 1 at the employer 204 side indicates that, for the purpose of drawing from a license pool, a user is affiliated with one employer. The employer 204 has a cardinality of asterisk * with respect to users 101, indicating an employer is configured to have a plurality of affiliated users simultaneously.

The license 408 represents an abstract classification for authorizing specific services. As depicted in FIG. 4, the license 408 serves as a parent abstraction (indicated by the hollow generalization arrow). The license 408 has two specializations: line license 410 and number license 412. Because these are specializations, the central controller 102 treats them as distinct objects for the purpose of tracking pool depletion and service authorization.

The line license 410 authorizes the establishment of private lines between users. As shown in FIG. 4, the line license 410 is associated with a line 210. This association indicates that a valid line license 410 is required to authorize the existence of a corresponding line 210 endpoint in a private wire connection. The central controller 102 (shown in FIG. 1) enforces this by only establishing or maintaining a line 210 if a corresponding line license 410 is active and allocated from the affiliated employer's license pool 406.

The number license 412 authorizes the assignment of private numbers to users. As shown in FIG. 4, the number license 412 has a direct association with an abstract number entity 420, which serves as an abstract number entity. This an abstract number entity 420 has a specialization relationship with both private number 214 and public number 212. However, as indicated by the specific logic of the license-based framework, the number license 412 is utilized to authorize the private number 214, whereas the public number 212 is a base-level resource provided to all users upon community membership without requiring a separate license allocation from the license pool 406.

The private number 214 represents a number assigned to a user that operates under a "deny-by-default" security posture, where all inbound calls are rejected unless an explicit permit rule is applied. As shown in the cardinality markers of FIGS. 4 and 2, each user 101 is configured to have zero or one (0..1) private number. Provisioning of a private number 214 requires a valid number license 412 from the employer's license pool 406.

The public number 212 represents a number assigned to a user that permits all calls unless a blocking rule is applied. Each user 101 has one public number 212 (cardinality of 1). Public numbers do not require number licenses 412 as they are automatically assigned to all users upon joining the community 202, representing the base level of connectivity within the global system.

The central controller 102 is configured to enforce license requirements by verifying that a user 101 has an appropriate license before provisioning a private number or private line. The central controller 102 receives requests from employer administrators 402 to add or remove licenses from the license pool 406 and maintains associations between licenses and the specific numbers or lines provisioned in the central database 104.

The central controller 102 is further configured to manage user affiliation changes. When a user 101 affiliates to a new employer 204, the central controller 102 updates the record in the central database 104. Because the licenses (410, 412) are composed (filled diamond) into the employer’s pool 406, they are not portable. Consequently, when a user 101 unaffiliates from an employer, the assigned private number 214 and any associated lines 210 (shown in FIG. 2) are cleared or deleted. While the user’s core profile and public number 212 are retained due to the user's independent existence (white diamond aggregation), access to licensed features is revoked until the user re-affiliates with an employer and receives new assignments.

Employer administrators 402 manage license assignments via the administration interface 106 (shown in FIG. 1). The interface provides real-time license pool management showing current allocations versus usage, license assignment tools for specific users, and access control list (ACL) management for configuring employer-level blocking and permit rules. This interface also allows administrators to set default number visibility settings for all users affiliated with the employer.

In some embodiments, the licensing and resource allocation mechanisms may be implemented using alternative models beyond the specific line license and number license constructs described above. The system may employ subscription-based licensing where users or organizations subscribe to service tiers that include various combinations of features, connection types, or usage limits without explicitly allocating individual line or number licenses. Consumption-based licensing may charge based on actual usage metrics such as minutes consumed, connections established, or active users per billing period. Capacity-based licensing may allocate connection capacity, concurrent call limits, or bandwidth resources rather than discrete line allocations. Feature-based licensing may enable or disable specific platform capabilities (such as private lines, public directory listing, intelligent routing, or API access) based on license entitlements without tying licenses to specific numbers or lines. The licensing system may operate as a resource orchestration layer that manages access to platform capabilities according to contractual entitlements while abstracting away the specific resource allocation mechanisms. In some implementations, no explicit licensing verification occurs at connection time, with usage tracking and enforcement happening through separate billing or compliance systems. The license pool architecture represents one embodiment optimized for traditional voice line provisioning contexts, but the broader platform supports flexible licensing constructs that adapt to various business models and commercial arrangements. Organizations may mix multiple licensing models, applying different models to different user populations or service types within the same platform instance.

### Number and Private Wire Relationships

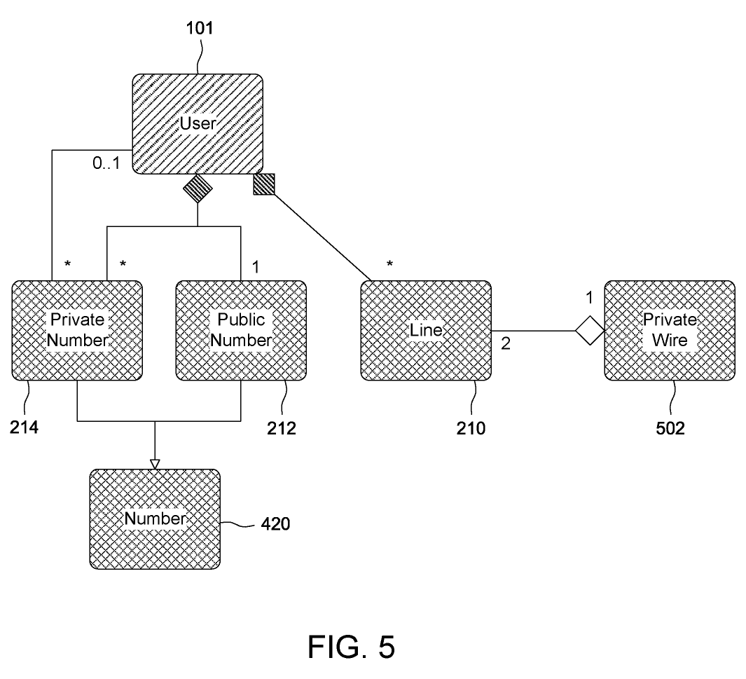

FIG. 5 illustrates a domain model showing number and line abstractions in accordance with an example embodiment. FIG. 5 particularly depicts number and line relationships managed by the central controller 102 (shown in FIG. 1). As illustrated, the domain model defines the structural requirements for establishing on-demand and dedicated communication paths between users. The model utilizes a specialization hierarchy where a public number 212 and a private number 214 are both specialized types of an abstract number entity 420.

Each user 101 is associated with a plurality of communication endpoints. As shown by the cardinality markers in FIG. 5, each user 101 is configured with one public number 212. Furthermore, a user 101 is configured to have zero or more * private numbers 214 and zero or more * lines 210. While public numbers 212 and private numbers 214 are utilized for general dialing and identification, the lines 210 serve as the discrete endpoints for dedicated, point-to-point connections.

The private wire 502 represents a dedicated logical or physical connection established between two users. As illustrated by the filled diamond (composition relationship) in FIG. 5, a private wire 502 is composed of two line 210 endpoints. This signifies that the private wire 502 owns the logical lifecycle of its constituent line 210 endpoints. As shown by the 1 cardinality marker on the private wire 502 side, each individual line 210 endpoint is configured to be associated with one private wire 502. This ensures that the communication path remains exclusive and dedicated between the two users, preventing the resource from being over-subscribed or shared across multiple active wires.

In some embodiments, the central controller 102 is configured to automatically assign a public number 212 to each user 101 when the user is added to the community 202 (shown in FIG. 2). Public numbers 212 permit all calls unless a blocking rule is applied. These numbers are published in the global community directory (described in FIG. 3) and are searchable by all community members. The central controller 102 enables any user 101 to search the directory and, upon locating a contact, initiate an immediate call, add the contact to a directory (e.g., general directory 302, personal director 304 shown in FIG. 3), or request a more permanent connection such as a private wire 502.

In some embodiments, the central controller 102 is configured to assign additional private numbers 214 to users 101 based on license availability (as described in connection with FIG. 4). In some implementations, private numbers 214 operate under a "deny-all" security posture and are excluded from the global community directory. Access to a private number 214 is restricted to contacts specifically permitted by the owner. When a contact is permitted, the central controller 102 adds them to an access control list (ACL) and enables the private number 214 details to appear in the permitted user's private directory 304.

As an extension of the number relationships in FIG. 5, in some embodiments, the central controller 102 is configured to manage team numbers. These utilize the logical framework of a public number 212 or private number 214 but are associated with a group of users 101 who are members of a team. All team members are configured to receive calls to the team number. The central controller 102 enforces team-based data governance and maintains settings that determine directory publication based on team member permissions.

The central controller 102 is further configured in some embodiments to provision virtual speed-dial links. Unlike the private wire 502, which provides an always-on dedicated connection, virtual speed-dial links comprise dedicated back-to-back numbers. These links place calls through the communications systems 116 (shown in FIG. 1) each time the speed-dial button is activated. The central controller 102 configures call screening rules to ensure each number in the pair is exclusively dedicated to calling the counterparty, providing a guaranteed connection for users in environments where SIP trunks for private wires 502 are not supported.

In some embodiments, the central controller 102 provisions the endpoints shown in FIG. 5 as extensions in local communications systems via the communication system interfaces 114. For each assigned number or line, the edge agent 112 (shown in FIG. 1) creates an extension using a portion of a unique global identifier (UGI). For example, for a UGI of 888-001-12345-1-1122334455, the edge agent 112 creates extension 1122334455 and provisions a corresponding resource button on the user's turret 117 or client application 110.

In some embodiments, the central controller 102 maintains the state of all connections in the central database 104. For private wires 502, the controller ensures constant availability by establishing dedicated routing between the line 210 endpoints. The edge agents 112 continuously monitor user presence and the status of these extensions, transmitting real-time updates to the central controller 102 to ensure that the availability of public numbers 212, private numbers 214, and private wires 502 is accurately reflected across the global community directory and user interfaces.

### Employer, Enterprise, and CXVID Relationships

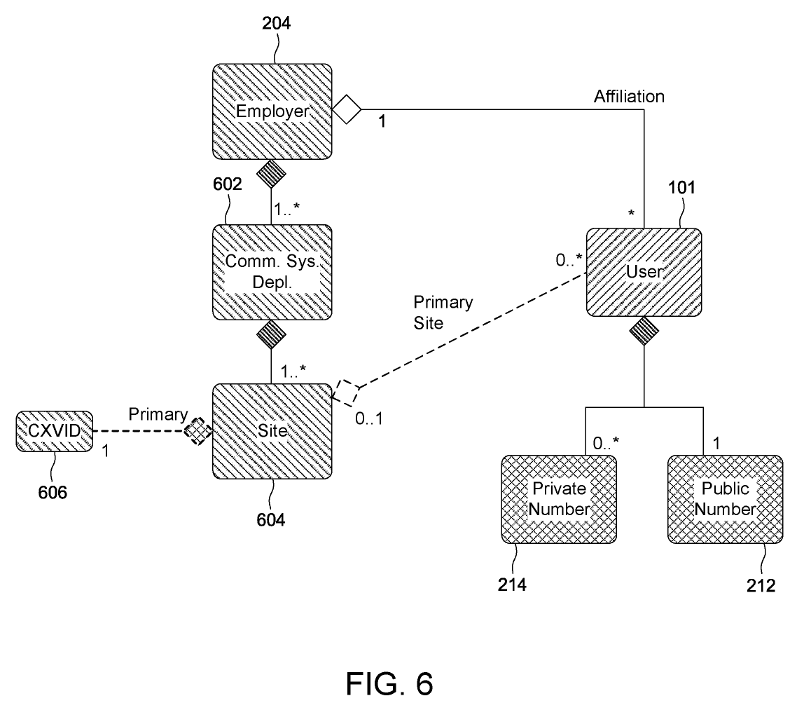

FIG. 6 illustrates a domain model showing employer deployments and voice identifiers in accordance with an example embodiment. FIG. 6, in this example, depicts the relationships between employers 204, users 101, communication system deployments 602, sites 604, and voice identifiers (CXVIDs) 606. As shown in FIG. 6, an employer 204 has an affiliation relationship with users 101. This is an aggregation relationship (represented by the hollow diamond at the employer end), where an employer 204 has a cardinality of many * with respect to users 101, and each user is affiliated with one (1) employer.

The structural hierarchy of the communication network is defined by composition relationships (represented by solid diamonds). An employer 204 comprises one or more (1..*) communication system deployments 602. Each communication system deployment 602, in turn, comprises one or more (1..*) sites 604. Each site 604 comprises exactly one (1) CXVID 606. This 1-to-1 composition ensures that every physical or logical site possesses a unique system identifier within the voice network.

A user 101 is linked to the infrastructure via a primary site association. This is an aggregation relationship (hollow diamond at the site end) where a user 101 has a cardinality of zero or one (0..1) with respect to a site 604, while a single site may serve as the primary site for many * users. As discussed in connection with FIG. 6, the CXVID 606 linkage (via the primary site) enables a user 101 to be called via the voice network using the numbering plan described herein. The CXVID 606 enables the communications systems 116 (shown in FIG. 1) to route calls to the correct local communication system based on the system identifier embedded in unique global identifiers.

In the example implementation shown in FIG. 6, each user 101 in this model maintains one public number 212 and zero or more (0..*) private numbers 214. The central controller 102 uses the primary site association to determine the appropriate CXVID 606 when generating unique global identifiers for users 101. Referring also to FIG. 1, when generating a unique global identifier for a user 101, the central controller 102 queries the central database 104 to identify the user's primary site, retrieves the CXVID 606 associated with that site, and incorporates the CXVID 606 as the system identifier in the unique global identifier. This enables the communications systems 116 to route calls to the correct local communication system based on the system identifier embedded in the called number.

### Public Number Call Flow

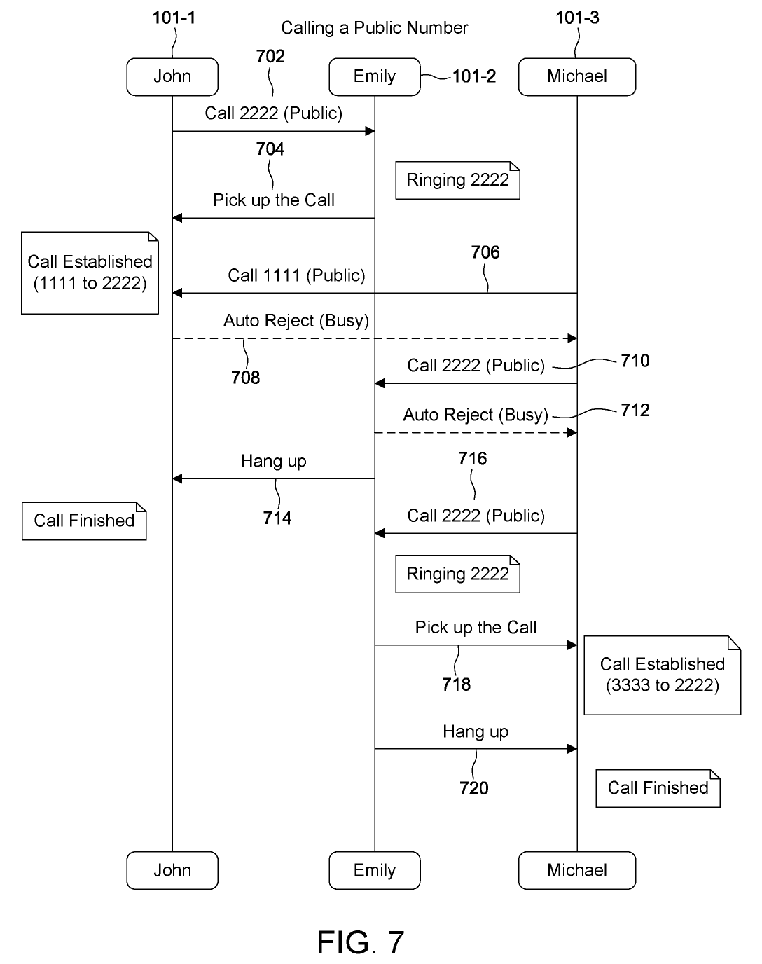

FIG. 7 depicts a call flow for public number communications in accordance with an example embodiment. The call flow illustrates how the system 100 (shown in FIG. 1) handles multiple calling parties and busy conditions when a first user 101-1 (John), a second user 101-2 (Emily), and a third user 101-3 (Michael) communicate via public numbers.

As shown at element 702, first user 101-1 (John) initiates a call to second user 101-2 (Emily) by calling public number 2222. The call rings at second user 101-2's (Emily) turret 117, second user 101-2 (Emily) picks up the call at element 704 and the call is established between 1111 (representing the public number of the first user 101-1 (John)) and public number 2222.

While this call is active, at element 706, third user 101-3 (Michael) attempts to call first user 101-1 (John) at public number 1111. The system determines that first user 101-1 (John) is busy and automatically rejects the incoming call as indicated at element 708. Subsequently, at element 710, third user 101-3 (Michael) attempts to call second user 101-2's (Emily) public number 2222. At element 712, the call is also automatically rejected due to the busy status of second user 101-2 (Emily).

At element 714, first user 101-1 (John) and second user 101-2 (Emily) complete their call and hang up. The call finishes and both public numbers become available. At element 716, third user 101-3 (Michael) places another call to second user 101-2's (Emily) public number 2222. Because the number is no longer busy, the voice network permits the call, second user 101-2 (Emily) picks up, and the call successfully establishes between 3333 (representing third user 101-3 (Michael)) and public number 2222, as shown by element 718. At element 720, the call is eventually terminated when either party hangs up and the call is finished.

### Private Number Call Flow

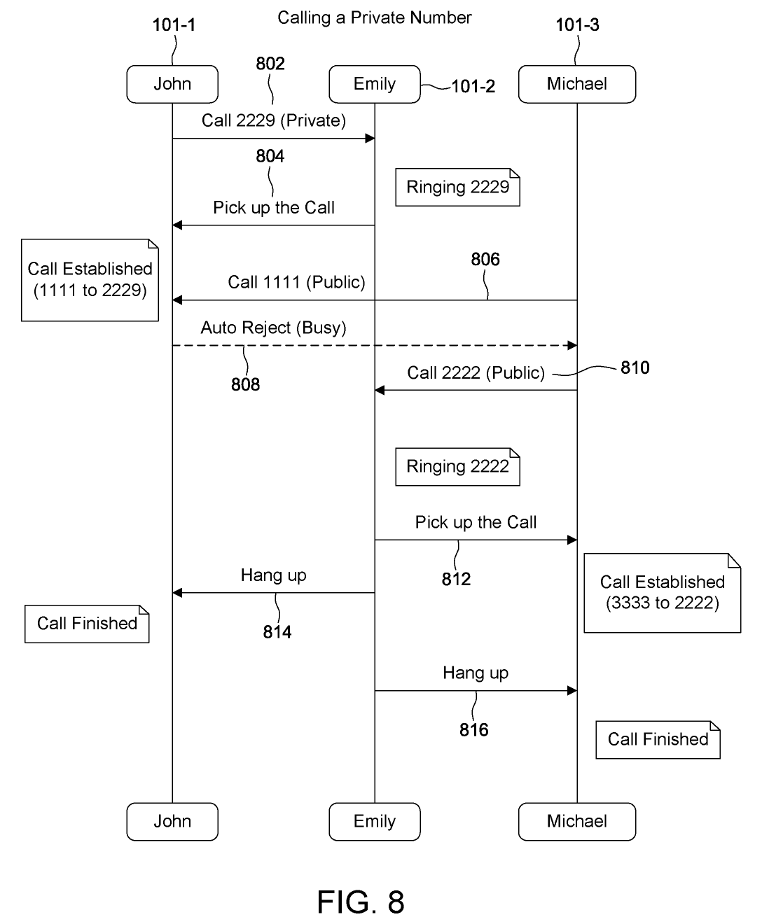

FIG. 8 depicts a call flow for private number communications in accordance with an example embodiment. This call flow demonstrates how a user is configured to maintain availability on a public number 212 (e.g., shown in FIG. 2) while engaged on a private number 214 (e.g., shown in FIG. 2), enabling call management and availability control.

As shown at element 802, a first user 101-1 (John) initiates a call to a second user 101-2 (Emily) by calling private number 2229. The call causes the second user 101-2's (Emily) station to ring. At element 804, second user 101-2 (Emily) picks up the call, and the call is established between 1111 (representing first user 101-1 (John)) and private number 2229.

While the call between first user 101-1 (John) and private number 2229 is active, at element 806, a third user 101-3 (Michael) attempts to call first user 101-1 (John) at public number 1111. As shown at element 808, the system determines that first user 101-1 (John) is busy and issues an Auto Reject (Busy). However, at element 810, when third user 101-3 (Michael) initiates a call to second user 101-2’s (Emily) public number 2222, the system permits the call. The call rings, and at element 812, second user 101-2 (Emily) picks up, and a second call is established between 3333 (representing third user 101-3 (Michael)) and public number 2222. Because public number 2222 and private number 2229 are distinct, second user 101-2 (Emily) is able to maintain simultaneous active calls on different assigned numbers.

At element 814, first user 101-1 (John) and second user 101-2 (Emily) hang up, and the call to the private number is marked as finished. At element 816, third user 101-3 (Michael) and second user 101-2 (Emily) eventually hang up, and that call is also marked as finished. This demonstrates that when a user is engaged on one number, they remain available for incoming calls on other assigned numbers.

In some embodiments, a private number 214 is configured to be assigned to only one user at a time. The assignment of a private number 214 to a counterparty is asymmetric; each user, such as first user 101-1 (John) or second user 101-2 (Emily), independently manages their private number assignments.

### User Discovery and Community Building Workflow

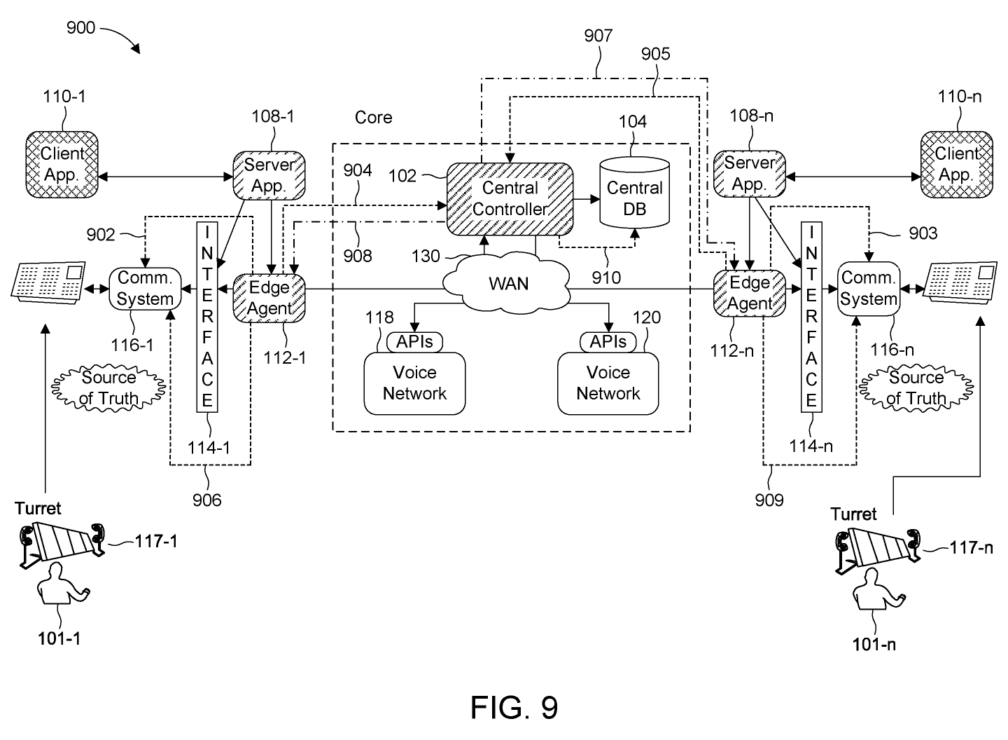

FIG. 9 depicts a user discovery workflow 900 for building the community directory in accordance with an example embodiment. This workflow executes to consolidate user information from a plurality of local communications systems 116 into the central database 104.

As illustrated at elements 902 and 903, edge agents 112-1 and 112-n collect user information from local communications systems 116 via communication system interfaces 114. These local systems are labeled as the "Source of Truth" for user data. The edge agents 112 query these systems for user metadata, such as user identifiers and names.

At elements 904 and 905, the edge agents 112-1 and 112-n, correspondingly, transmit the collected user lists to the central controller 102 via the wide area network 130. At element 910, the central controller 102 adds the users 101 to the community maintained in the central database 104, consolidating information from multiple sites into a unified global directory.

At elements 908 and 907, the system provides feedback to edge agent 112-1 and edge agent 112-n, correspondingly. Specifically, the central controller 102 communicates with edge agents 112-1 and 112-n, correspondingly, to facilitate the provisioning process including by providing user public numbers to the edge agents 112.

At elements 906 and 909, the edge agents 112-1 and 112-n provision extensions and resource buttons in the users' favorites within the local communications systems 116-1 and 116-n, correspondingly.

The central controller 102 is responsible for assigning a unique identifier (which may function as a public number 212) to each user 101. This identifier is transmitted back to the edge agents 112 to ensure consistency across the network.

The edge agents 112 use this information to finalize the local setup. For example, edge agent 112-1 creates a local extension in the communication system 116-1 via the interface 114-1 and configures a resource button for user 101-1. This allows the user to receive incoming calls on their assigned global number.

This workflow executes periodically, such as every 24 hours, to synchronize user information. It also triggers in response to specific events, including the addition, modification, or removal of users in the local systems, ensuring the central database 104 remains the accurate global directory.

### Community Search and Call Initiation Workflow

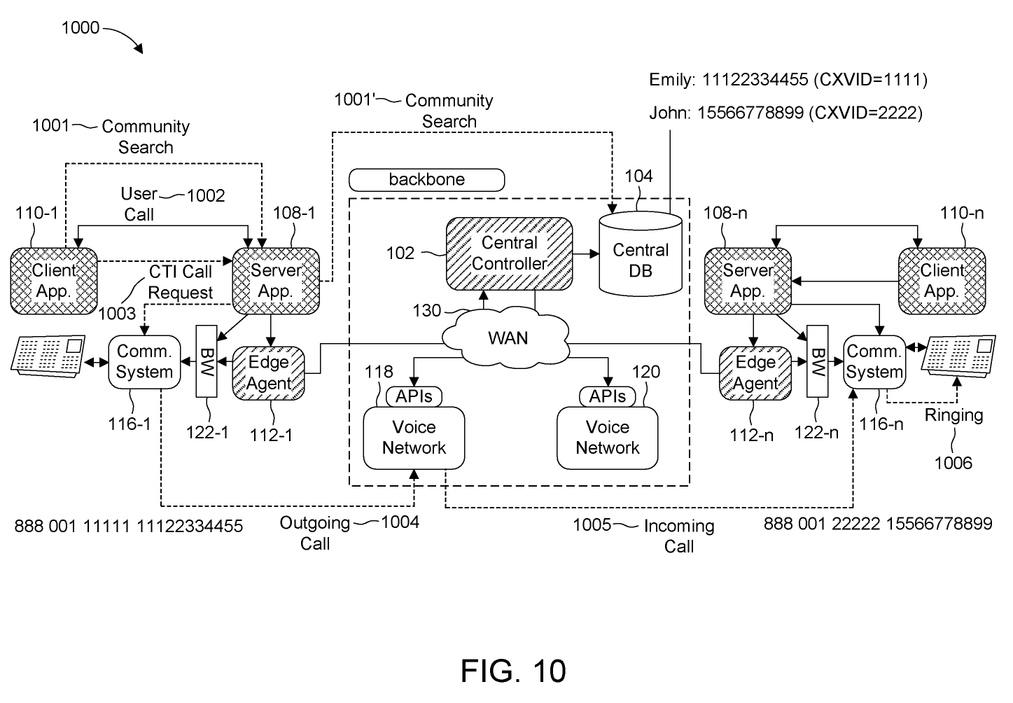

FIG. 10 depicts a community search and call initiation workflow 1000 in accordance with an example embodiment. This workflow illustrates how users discover and communicate with other users in a community.

Referring also to FIG. 6, as shown in the example, Emily has number 11122334455 (with voice identifiers (CXVID) =11111) and John has number 15566778899 (with CXVID=22222). At element 1001, Emily performs a community search via client application components 110-1. The client application components 110 transmit search requests to server application component 108-1 (from FIG. 1), which forwards the requests to the central controller 102 at element 1001'.

The central controller 102 queries the central database 104 for contact records matching the search criteria and returns results filtered based on privacy settings to only return contact records for publicly visible numbers or numbers for which permission has been granted.

At element 1002, user 110-1 (e.g., Emily) initiates a user call by selecting a second user (e.g., John) from the search results and activating a call control in the client application component 110-1. At element 1003, the client application component 110-1 transmits a CTI (Computer Telephony Integration) call request to the edge agent 112-1 (from FIG. 1) via server application component 108-1.

At element 1004, the communication system 116-1 generates an outgoing call from Emily's extension to the called number 888-001-22222-15566778899. The local communication system transmits the call with calling number 888-001-11111-11122334455 via voice network 118. At element 1005, the call arrives as an incoming call at the destination local communication system, communication system 116-n. At element 1006, John's turret 117-n rings, and when John answers, the call establishes between the first user (Emily) and the second user (John).

### Private Line Provisioning Workflow

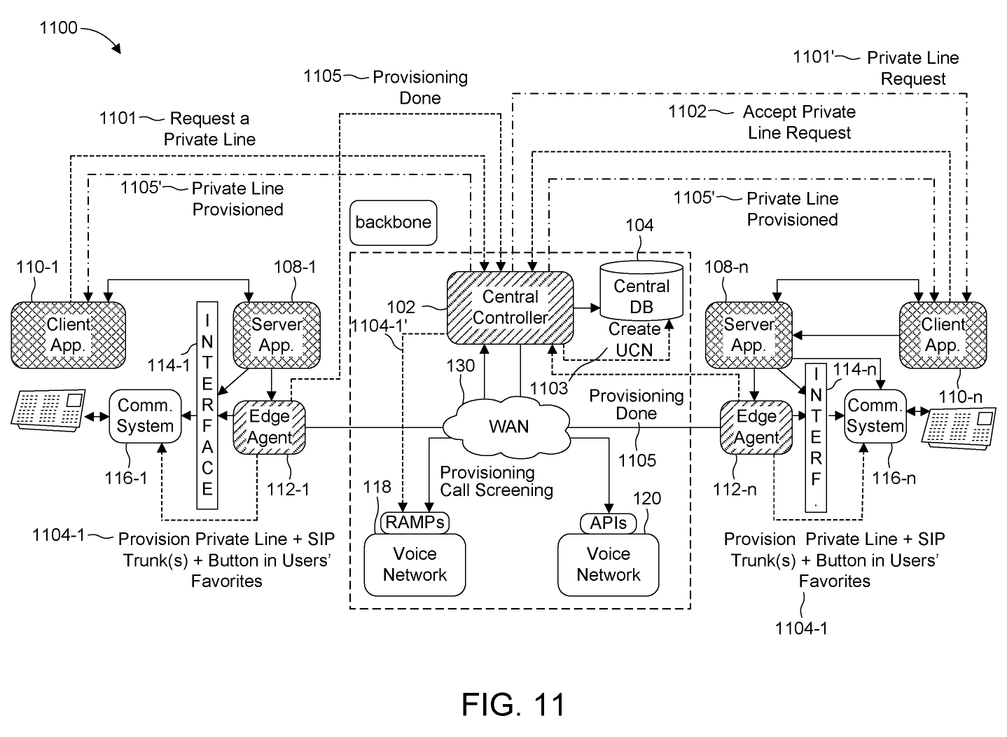

FIG. 11 depicts a private line provisioning workflow 1100 in accordance with an example embodiment. This workflow demonstrates the automated provisioning of dedicated private lines between users 101 upon acceptance of connection requests.

At element 1101, a first user 101-1 generates a private line request via client application component 110-1, specifying a second user 101-n as the destination for the private line. In an example implementation, the client application component 110-1 transmits the request to the central controller 102 via server application component 108-1. At element 1101', the second user 101-n receives notification of the private line request. In an example implementation, the central controller 102 communicates the private line request to client app 100-n via server application component 108-n.

At element 1102, the second user 101-n accepts the private line request via client application component 110-n. At element, 1103, the central controller 102 generates a unique connection number (UCN) for the private line and creates a private line record in the central database 104 with status transitioning to "Provisioning."

At element 1104-1, the central controller 102 provisions call screening rules in the communications systems 116 to block any number other than the designated counterparty endpoints from calling either private line number. In an example implementation, this is performed by a role-based access management and provisioning system (RAMPS) as indicated by element 1104-1' in FIG. 11. RAMPS and automated provisioning service can be used interchangeably. In some embodiments, at elements 1104-1, the central controller 102 orchestrates provisioning via edge agents 112-1 and 112-n, which provision private line extensions, SIP trunks, and buttons in users' favorites in the local communication systems via communication system interfaces 114-1 and 114-n.

At element 1105, when provisioning completes at all components, the edge agents 112 and communications systems 116 transmit provisioning completion notifications to the central controller 102. At elements 1105', the central controller 102 transitions the private line status to "Provisioned" and transmits notifications to both users via client application components 110-1 and 110-n indicating that the private line has been successfully provisioned and is ready for use.

In some embodiments, the central controller 102 receives a private line request from a first user 101-1 specifying a second user 101-n. The central controller 102 generates a unique connection number (UCN) for the private line. The UCN is used to identify the private line throughout the system 100. The central controller 102 creates a private line record in the central database 104 with status "Requested." The private line record includes: a from-end enterprise identifier, a from-end user identifier, a from-end location, a from-end system identifier, a to-end enterprise identifier, a to-end user identifier, a to-end location, a to-end system identifier, the UCN, the status, provisioning state flags, and a request date.

The central controller 102 transmits an acceptance request to the second user 101-n via client application component 110-n. The second user 101-n receives a notification of the private line request and is configured to accept or decline the request. If the second user 101-n declines the request, the central controller 102 updates the private line status to "Declined" and notifies the first user 101-1 of the declination.

Upon acceptance by the second user 101-n, the central controller 102 transitions the private line status to "Provisioning" and orchestrates provisioning across multiple components. The central controller 102 transmits provisioning instructions to edge agent 112-1 for communication system interface 114-1, transmits provisioning instructions to edge agent 112-n for communication system interface 114-n, and transmits provisioning instructions to the communications systems 116 via routing and admission policy servers (RAPS).

The edge agent 112-1 provisions a private line via communication system interface 114-1 by creating an extension for the from-end of the private line, provisioning a SIP trunk if necessary, and creating a button in the favorites of user 101-1 to access the private line. The edge agent 112-1 transmits a provisioning completion notification to the central controller 102. The central controller 102 updates a provisioning state flag (provisioned_from_end) to true in the private line record.

The edge agent 112-n performs corresponding provisioning via communication system interface 114-n for the to-end of the private line and transmits a provisioning completion notification to the central controller 102. The central controller 102 updates a provisioning state flag (provisioned_to_end) to true in the private line record.

The central controller 102 provisions call screening rules in the communications systems 116 via APIs. The call screening rules ensure that the private line numbers are exclusively dedicated to the private line connection and block any other numbers from calling either endpoint. The communications systems 116 transmit a provisioning completion notification to the central controller 102. The central controller 102 updates a provisioning state flag (provisioned_psx) to true in the private line record.

When all provisioning state flags are true, the central controller 102 verifies that all components have successfully completed provisioning. The central controller 102 transitions the private line status from "Provisioning" to "Provisioned." The central controller 102 transmits notifications to both the first user 101-1 and the second user 101-n indicating that the private line has been successfully provisioned and is ready for use.

### Private Line State Machine

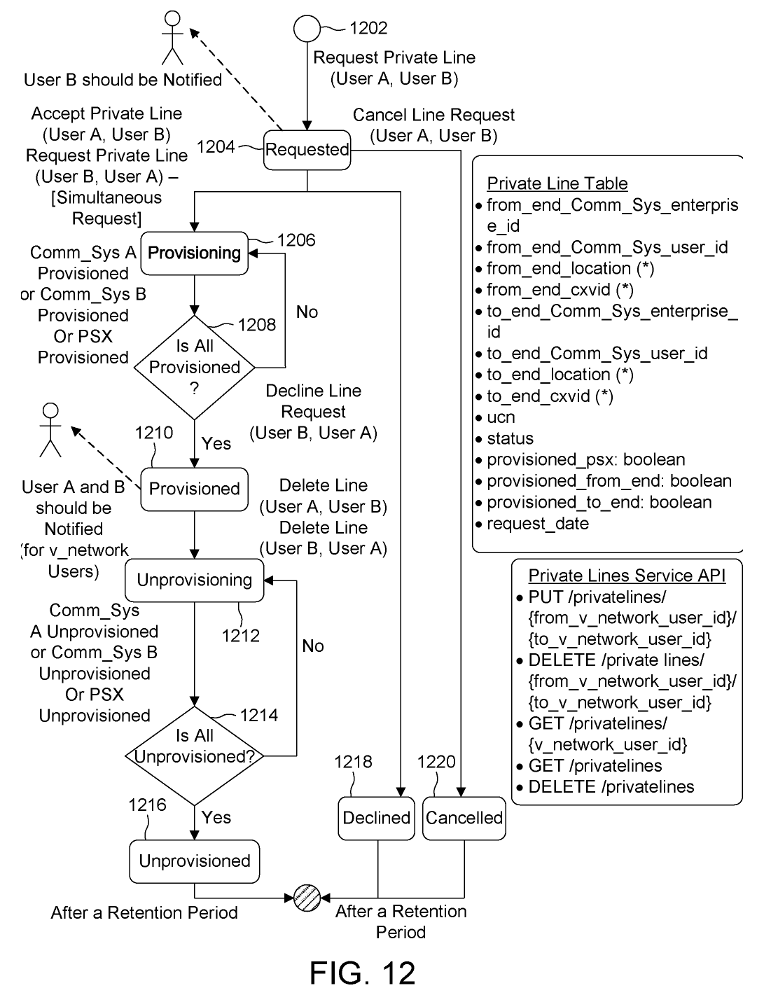

FIG. 12 depicts a state machine for a private line management in accordance with an example embodiment. The state machine governs the lifecycle of private line requests from initial request through provisioning, use, and eventual unprovisioning.

At element 1202, a user 101 submits a request for a private line between User A and User B. The private line enters a "Requested" state 1204. From the Requested state 1204, the private line is configured to transition to: (1) a "Provisioning" state 1206 if User B accepts the request or if both users simultaneously request a private line with each other, (2) a "Declined" state 1216 if User B declines the request, or (3) a "Cancelled" state 1218 if User A cancels the request before acceptance.

In an example implementation, in the Provisioning state 1206, the system 100 (shown in FIG. 1) monitors provisioning state flags including provisioned_from_end, provisioned_to_end, and provisioned_psx. At element 1208, the central controller 102 (from FIG. 1) checks whether all components have completed provisioning by verifying that all provisioning state flags are true. When all flags are true, the private line transitions to the "Provisioned" state 1210, and at this point Users A and B are notified that the private line is ready for use.

From the Provisioned state 1210, either user is configured to delete the private line. When a user deletes a private line, the central controller 102 transitions the private line to an "Unprovisioning" state 1212. At element 1214, the central controller 102 monitors unprovisioning completion by checking whether all components (Comm_Sys A, Comm_Sys B, and PSX) have completed unprovisioning. When all components complete unprovisioning, the private line transitions to an "Unprovisioned" state 1220. After a retention period, the private line record is removed from the central database 104 (shown in FIG. 1).

Private line records in the Declined state 1218 or Cancelled state 1220 are also maintained for a retention period before removal from the central database 104. The Private Line Table shown in FIG. 12 stores attributes including from_end_Comm_Sys_enterprise_id, from_end_Comm_Sys_user_id, from_end_location, from_end_cxvid, to_end_Comm_Sys_enterprise_id, to_end_Comm_Sys_user_id, to_end_location, to_end_cxvid, ucn (unique connection number), status, and the Boolean provisioning flags.

### Private Line Provisioning via Administrative Interface

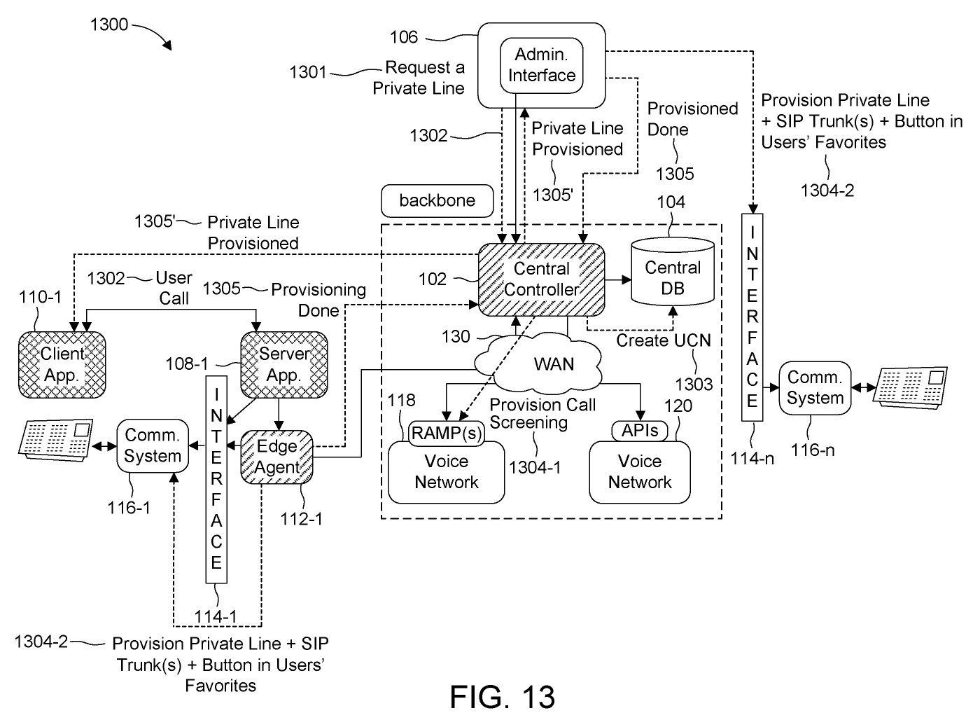

FIG. 13 depicts a private line provisioning workflow 1300 initiated via the administrative interface 106 in accordance with an example embodiment. This workflow enables administrators to create private lines between users, including creating private lines with users not in a community 202 (shown in FIG. 2).

At element 1301, an administrator accesses the administration interface 106 and submits a request to create a private line. At element 1302, the request is transmitted to the central controller 102, which, in turn at element 1303 creates a UCN at the central database 104. At element 1304-1, the central controller 102 provisions call screening rules in the communications systems 118. In an example implementation, this is implemented using a RAMP(s).

At elements 1304-2, the central controller 102 orchestrates provisioning via edge agent 112-1, which provisions the private line, SIP trunks, and buttons in users' favorites in the local communication system. At element 1305, when provisioning completes, the edge agent 112-1 and communications systems 116 transmit provisioning completion notifications to the central controller 102. At elements 1305', the central controller 102 notifies the user 101-1 and user 101-1 (shown in FIG. 1) via client application component 110-1 and 110-n, correspondingly that the private line has been provisioned.

Because the second user is not a community member, no acceptance step is performed. The central controller 102 generates a UCN and transitions to the Provisioning state. The central controller 102 orchestrates provisioning via communication system interfaces 114-1, 114-n (from FIG. 1) and communications systems 116 as described above. When provisioning completes, the central controller 102 notifies the first user 101-1 via client application component 110-1 that the private line has been provisioned.

While the status fields described herein may include values such as "Requested", "Provisioning", "Provisioned", "Unprovisioned", "Unprovisioning", "Declined", and "Cancelled", other status indicators or state management approaches may be used in alternative embodiments.

### Simplified Private Line State Machine

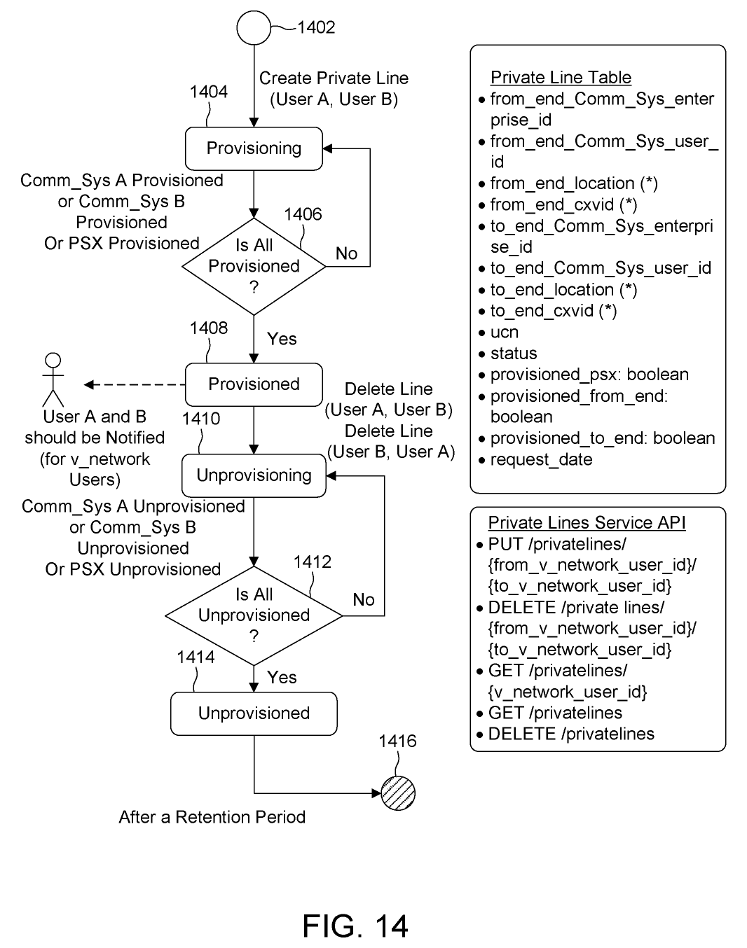

FIG. 14 depicts a simplified state machine for private line creation in accordance with an example embodiment. This simplified flow is used when creating private lines administratively without requiring user acceptance.

At element 1402, a private line 210 is created between User A and User B. The private line immediately enters the "Provisioning" state 1404. At element 1406, the system 100 (from FIG. 1) checks whether all components (Comm_Sys A, Comm_Sys B, and PSX) have completed provisioning. When all provisioning is complete, the private line transitions to the "Provisioned" state 1408, and Users A and B are notified.

From the Provisioned state 1408, either user can delete the private line, transitioning it to the "Unprovisioning" state 1410. At element 1412, the system 100 checks whether all components have completed unprovisioning. When complete, the private line transitions to the "Unprovisioned" state 1414. At element 1416, after a retention period, the private line record is removed from the central database 104 (shown in FIG. 1).

### Computing Environment

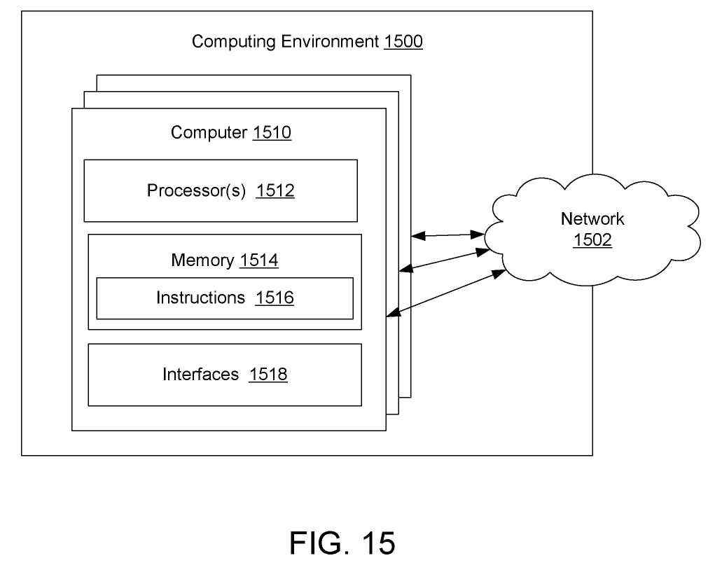

FIG. 15 depicts a computing environment 1500 suitable for implementing example embodiments in accordance with an example embodiment. The computing environment 1500 includes a computer 1510 coupled to a network 1502. The computer 1510 includes one or more processors 1512, memory 1514, instructions 1516, and interfaces 1518.

Processors 1512 execute instructions 1516 stored in memory 1514 to implement the methods described herein, including the central controller 102 (from FIG. 1) functions, edge agent 112 (from FIG. 1) functions, and server application component 108 (from FIG. 1) functions. Interfaces 1518 couple the computer 1510 to network 1502 to communicate with other components of the system 100 (from FIG. 1).

From a hardware standpoint, processors 1512 include one or more components, such as microprocessors, for performing arithmetic and logical operations for program execution. Memory 1514 includes storage media for program and data storage and random access memory for temporary data and program instruction storage. Interfaces 1518 include network interfaces such as Ethernet or wireless interfaces for communicating via network 1502.

From a software standpoint, instructions 1516 include software resident on storage media which, when executed, directs the processors 1512 in performing the functions described herein. The software runs on an operating system and adheres to protocols such as HTTPS, WebSocket, SIP, and other connection or connectionless protocols.

### Provisioning Workflow

In an example embodiment, the central controller 102 (from FIG. 1) is configured to provision a plurality of extensions in corresponding ones of a plurality of local communications systems via the communication system interfaces 114 (from FIG. 1), wherein each extension corresponds to a contact record in the central database 104 (from FIG. 1). An extension in a local communication system corresponds to a number assigned to a user 101. The central controller 102 transmits provisioning instructions to the edge agents 112 (from FIG. 1), and the edge agents 112 execute the provisioning in the local communications systems via the communication system interfaces 114.

To provision a number for a user 101, the edge agent 112 creates an extension in a local communication system via the communication system interface 114 with the user number portion of the unique global identifier. For example, for unique global identifier 888-001-12345-1-1122334455, the edge agent 112 creates extension 1122334455 in the local communication system. The edge agent 112 creates a resource button in the user's favorites to enable the user to receive incoming calls on this number. The resource button displays the number and enables graphical control of call handling.

The central controller 102 receives a selection of one or more of the plurality of extensions and provisions a plurality of graphical elements corresponding to the selection under a user profile or team profile. Each graphical element provides access to information from the corresponding contact record. The central controller 102 establishes communication paths between each of the plurality of extensions based on the unique global identifiers assigned to the corresponding contact records.

The graphical elements comprise one or more of: a resource button in user favorites that enables incoming calls from one or more of the plurality of extensions, a speed-dial button that enables direct calling to one or more of the plurality of extensions, a presence indicator that shows availability status of one or more of the plurality of extensions, and call control buttons. When adding a button, the user 101 is configured, in some embodiments, to edit a label for the button via the client application component 110 (from FIG. 1). By default, the label comprises the forename and surname of the contact. The user 101 is also configured, in some embodiments, to select a color for the button and configure alerting functions for inbound calls.

The presence indicator is configured to display whether a user 101 is logged into a turret 117 (from FIG. 1) associated with a particular extension, which type of turret 117 the user is logged into, whether the user 101 is currently busy on an active call, and real-time presence status updates received from the edge agent 112. This enables other users to determine availability before initiating communications.

The edge agents 112 are configured to refresh user presence information by monitoring whether users 101 are logged into turrets117, detecting what type of turret each user is logged into, detecting when users 101 are on active calls, and transmitting real-time presence updates to the central controller 102 for display via the presence indicators. The presence updates are transmitted to the client application components 110 to provide real-time availability information.

### Generic Routing Rules

In some embodiments, for outgoing calls, a local communication system is configured to manipulate the calling line identification by adding a prefix comprising the application prefix and the system identifier. For example, when user 101-1 with extension 1122334455 in a local communication system having system identifier 12345 places an outgoing call, the local communication system adds prefix "001-12345" to generate calling line identification 001-12345-1122334455. The local communication system transmits the call to a communication system 116-1 (from FIG. 1) via a SIP trunk.

For incoming calls, a local communication system is configured to receive calls from the communications systems 116 (from FIG. 1) with the outgoing call prefix. For example, when a call is received with called number 001-98765-13344556677, the local communication system removes prefix "001-98765" to identify destination extension 13344556677. The local communication system then routes the call to turret 117-n (from FIG. 1) associated with that extension.

These generic routing rules are created during provisioning of a local communication system for use with the system 100 (from FIG. 1). The edge agent 112 configures the routing rules via the communication system interface 114.

### Privacy Controls and Visibility Settings

In some embodiments, the central controller 102 (from FIG. 1) is configured to receive, via one or more input devices, one or more visibility settings, each visibility setting corresponding to a rule that defines access restrictions to information for one or more of the plurality of extensions, and enforce privacy policies based on the one or more visibility settings. The privacy policies include user-controlled publication settings for numbers in a community directory, team-based data governance controls, and configurable blocking rules for incoming communications.

The central controller 102 enables each user 101 to configure number visibility settings via the client application component 110 (from FIG. 1). Visibility settings include: public visibility, wherein the number is published in the global community directory and searchable by all community members, and private visibility, wherein the number is excluded from the global community directory and only accessible to specifically permitted users.

The central controller 102 enables employer administrators 402 (from FIG. 4) to set default number visibility for users 101 affiliated with the employer 404 (from FIG. 4). Employer administrators 402 are configured to manage whitelists and blacklists via the administration interface 106 (from FIG. 1). The central controller 102 applies employer-level access control lists in addition to user-level settings.

The central controller 102 is configured to manage call settings for each user 101 including: do not disturb settings that reject all incoming calls, automatic forward settings that redirect calls to alternate destinations, and notification settings that control how users are alerted to incoming communications. Users 101 configure these settings via the client application component 110, and the central controller 102 transmits the settings to the edge agents 112 (from FIG. 1) for implementation in the local communications systems via the communication system interfaces 114 (from FIG. 1).

### Communication System Routing and Call Screening

In some embodiments, the system 100 (from FIG. 1) includes a plurality of communications systems 116 (from FIG. 1) configured to route communications between a plurality of turrets 117 (from FIG. 1) associated with the plurality of extensions. In the example embodiment depicted in FIG. 1, the communications systems 116 include first voice network 118 and second voice network 120. The central controller 102 (from FIG. 1) manages routing rules for the communications systems 116. The communications systems 116 are configured to validate user identities, enforce access controls, and manage call routing.

The communications systems 116 include session border controllers and routing elements distributed across multiple geographic regions. The communications systems 116 implement call screening and access control based on rules managed by the central controller 102. When a call is received at a communication system 116, the communication system 116 extracts a calling number and a called number from the call signaling.

The communication system 116 queries access control rules associated with the called number. If an access control rule specifies that calls from the calling number are denied (a DENY rule), the communication system 116 rejects the call by routing to a null route and returning a SIP response code indicating rejection. If no deny rule applies, the communication system 116 applies permit rules. For public numbers 212 (from FIG. 2), the default behavior is to permit calls unless explicitly blocked. For private numbers 214 (from FIG. 2), the default behavior is to deny calls unless explicitly permitted.

The central controller 102 transmits access control list updates to the communications systems 116 via APIs. When a user 101 adds a block rule or permit rule via the client application component 110, the central controller 102 updates the central database 104 (from FIG. 1) and transmits the updated access control list to the appropriate routing elements in the communications systems 116. The routing elements implement the updated rules for subsequent call attempts.

The communications systems 116 implement comprehensive call screening based on access control lists managed by the central controller 102. For each incoming call, the communication system 116 performs multiple screening steps to determine whether to permit or deny the call.

The communication system 116 extracts the calling number and called number from the SIP INVITE message. The communication system 116 queries the central controller 102 or locally cached access control rules to retrieve rules associated with the called number. If the called number is a private number 214 (identified by number type indicator 2), the communication system 116 applies default deny behavior and checks for permit rules. If a permit rule exists for the calling number, the call is allowed to proceed. If no permit rule exists, the communication system 116 rejects the call by routing to a null route and returning a SIP response code 603 (Decline) or other appropriate response code.

If the called number is a public number 212 (identified by number type indicator 1), the communication system 116 applies default permit behavior and checks for deny rules (block rules). If a deny rule exists for the calling number, the communication system 116 rejects the call. If no deny rule exists, the call is allowed to proceed to the next screening step.

The communication system 116 then checks call admission control limits. The communication system 116 queries the current number of active calls for the called number. If the number of active calls equals or exceeds the maximum concurrent call limit configured for the called number, the communication system 116 rejects the call and returns a SIP response code indicating busy status. If the call admission control limit is not reached, the call is allowed to proceed to routing.

For private line numbers (identified by number type indicator 3), the communication system 116 implements strict call screening. The communication system 116 verifies that the calling number matches the counterparty endpoint of the private line 210 (from FIG. 2). Any call from a number other than the designated counterparty is automatically rejected. This ensures that private line numbers remain exclusively dedicated to the private line connection.

### Call Admission Control

In some embodiments, the communications systems 116 (from FIG. 1) implement call admission control by limiting the number of concurrent calls to a particular number. The central controller 102 (from FIG. 1) configures maximum concurrent call limits for each number. In an example embodiment, public numbers 212 (from FIG. 2) are configured with a maximum of one concurrent call. When a call is active on a public number 212 and a subsequent incoming call is received, the communication system 116 rejects the subsequent call and returns a SIP response code indicating busy status.

Private numbers 214 (from FIG. 2) and private line endpoints are configured, in some embodiments, with different call admission control limits. The central controller 102 stores call admission control settings in the central database 104 (from FIG. 1) and transmits the settings to the communications systems 116 during number provisioning.

### Call Forking

In some embodiments, the communications systems 116 (from FIG. 1) implement call forking to ring multiple turrets 117 (from FIG. 1) simultaneously. When a user 101 is logged into multiple turrets 117 (e.g., a hard turret at a desk location and a soft turret on a mobile device), the edge agent 112 (from FIG. 1) reports the presence information for all logged-in turrets to the central controller 102 (from FIG. 1). The central controller 102 maintains the presence information in the central database 104 (from FIG. 1) and transmits it to the communications systems 116.

When an incoming call is received for a user 101 who is logged into multiple turrets 117, the communication system 116 generates multiple call legs to ring all devices simultaneously (SIM RING). The call establishes to whichever turret 117 answers first, and the communication system 116 terminates the other call legs. This enables users to answer calls on any device they are currently using.

### Directory and Contact Management

In some embodiments, the central controller 102 (from FIG. 1) manages multiple types of directories to enable users 101 to organize contacts according to workflow requirements. The central controller 102 maintains a core directory in the central database 104 (from FIG. 1) that includes all contact records for all numbers in the system 100 (from FIG. 1). All other directories comprise filtered views of the core directory based on privacy settings, connection relationships, and user-defined organization.

The global community directory includes contact information for all public numbers 212 (from FIG. 2). Any user 101 is configured to search the global community directory to discover other users or teams. The central controller 102 filters search results based on privacy settings to exclude private numbers 214 (from FIG. 2) and blocked relationships.

Each user 101 has a private directory that lists private numbers 214 for which the user has been granted access permission. When an owner of a private number 214 grants permission to another user, the central controller 102 adds the private number 214 to that user's private directory. The private directory enables the user to view and access private numbers 214 without performing repeated searches.

Each user 101 is configured, in some embodiments, to create multiple personal directories 304 (from FIG. 3) to organize connected users according to user-defined categories. The central controller 102 receives requests via the client application component 110 (from FIG. 1) to create, rename, or delete personal directories 304. The central controller 102 receives requests to add or remove users from personal directories 304. The central controller 102 stores personal directory definitions and memberships in the central database 104.

Each user 101 has a private lines directory that lists all active private lines 210 (from FIG. 2) to other users or teams. The central controller 102 maintains the private lines directory showing all private lines 210 where the user is either the from-end or the to-end. The private lines directory enables users to view all established private lines 210, monitor their status, initiate calls on private lines, and delete private lines when no longer needed.

The central controller 102 enables users 101 to use the private lines directory to accept inbound private line requests, cancel existing private lines 210, and search for new connections to establish private lines.

### User Profile and Settings Management

In some embodiments, the central controller 102 (from FIG. 1) is configured to manage user profiles and settings accessible via the client application component 110 (from FIG. 1). User profile settings include: number visibility settings that control whether numbers are published in the global community directory, call settings including do not disturb and automatic forward configurations, notification settings that control how the user is alerted to incoming communications and events, and other user-specific preferences.

The central controller 102 receives profile updates via the client application component 110 and stores the updated settings in the central database 104 (from FIG. 1). The central controller 102 transmits relevant settings to the edge agents 112 (from FIG. 1) for implementation via the communication system interfaces 114 (from FIG. 1) and to the communications systems 116 (from FIG. 1) for implementation in routing and call screening rules.

### Data Privacy and Security

In some embodiments, the central database 104 (from FIG. 1) stores personally identifiable information (PII) that is protected in accordance with data protection regulations. The central controller 102 (from FIG. 1) implements security controls to protect PII including: encryption of data at rest in the central database 104, encryption of data in transit via TLS/SSL protocols, access controls limiting which microservices and users are configured to access specific data, and audit logging of all access to sensitive data.

Certain fields are designated as sensitive PII that are configured to not appear in software logs. Sensitive PII fields include: first name, last name, email address, and public number 212 (from FIG. 2) (which is configured to be logged partially to enable investigations while protecting full number visibility). Any exception to the prohibition on logging sensitive PII is reviewed and approved by designated security personnel.

The central controller 102 is configured to implement data retention policies. User data is retained while the user 101 remains active in the community 202 (from FIG. 2). When a user 101 is removed from the community 202, the central controller 102 maintains the user record for a retention period to preserve audit history and then purges the record. Private line records in terminal states (Declined 1216 (from FIG. 12), Cancelled 1218 (from FIG. 12), Unprovisioned 1220 (from FIG. 12)) are retained for a retention period and then removed from the central database 104.

### Certificate-Based Authentication

In some embodiments, the central controller 102 (from FIG. 1) implements certificate-based authentication for secure connections. The edge agents 112 (from FIG. 1) are provisioned with connection certificates that authenticate the edge agent to the central controller 102. When an edge agent 112 establishes a secure edge link to the central controller 102, the edge agent 112 presents its connection certificate. The central controller 102 validates the certificate and establishes the secure connection if the certificate is valid.

The central controller 102 includes an ingress controller that serves as a TLS endpoint for incoming connections. The ingress controller terminates TLS connections and forwards decrypted traffic to the appropriate microservices within the central controller 102. This architecture centralizes certificate management and simplifies security configuration.

### Service Type Summary

In some embodiments, the system 100 (from FIG. 1) supports multiple service types that address different use cases and privacy requirements. The service types include: public numbers 212 (from FIG. 2) (user and team), private numbers 214 (from FIG. 2) (user and team), virtual speed-dial links (user and team), and private lines 210 (from FIG. 2) (user and team).

User public numbers 212 are assigned to individual users 101 with user profile permission settings determining whether the number is published in the community directory. The use case is providing a discoverable contact number viewable in the global directory without connection requests.

User private numbers 214 are managed by individual users 101 and are not published in the community directory, being shared via invitation or chat. The use case is providing a private contact number not viewable in the global directory, where the user shares or invites counterparties to view the number.

Team public numbers are assigned to teams with team profile permission settings determining whether the number is published in the community directory. The use case is providing users 101 associated with a team profile with a discoverable team number viewable in the global directory without connection requests.

Team private numbers are managed by team users and are not published in the community directory, being shared by team users via invitation or chat. The use case is providing a private team contact number not viewable in the global directory, where team users share or invite counterparties to view the number.

User virtual speed-dial links comprise dedicated back-to-back numbers functioning as virtual speed-dials, not published in the community directory, where numbers only call the counterparty number. The use case is where users utilize a number that always calls a specific counterparty bi-directionally and is configured to receive calls on the same number.

Team virtual speed-dial links comprise dedicated back-to-back numbers functioning as virtual speed-dials, not published in the community directory, where numbers only call the counterparty number. The use case is where a team of users utilizes a number that always calls a specific counterparty team or user bi-directionally and is configured to receive calls on the same number.

User private lines 210 provide user-to-user point-to-point private line functionality. The use case is providing always-on private line functionality between two users ensuring constant availability.

Team private lines 210 provide team-to-team or team-to-user point-to-point private line functionality. The use case is providing always-on private line functionality between a team and another team or user ensuring constant availability for any team member.

### Client Application Features

In some embodiments, the client application components 110 (from FIG. 1) provide user features accessible via graphical user interfaces. The client application components 110 are deployed on user devices including desktop computers, laptop computers, tablet devices, and mobile devices. In an example embodiment, the client application components 110 run on an application workspace platform that provides a secure execution environment.

The client application components 110 provide features including: login and logout functionality with user authentication, community search enabling users 101 to search for other users or teams in the global community directory, profile management enabling users 101 to configure visibility and privacy settings, user network management for managing connections 206 (from FIG. 2) with other users and organizing directories, private number allocation for requesting and managing private numbers 214 (from FIG. 2), private line management for requesting, accepting, and managing private lines 210 (from FIG. 2) with other users, and user presence information displaying availability of contacts.

When a user 101-1 accesses the client application component 110-1, the user authenticates using credentials. The client application component 110-1 transmits authentication requests to the server application component 108-1 (from FIG. 1), which coordinates with the central controller 102 (from FIG. 1) to validate credentials and establish a user session. Once authenticated, the client application component 110-1 retrieves user profile information, directory information, and presence information from the central controller 102 via the server application component 108-1.

The client application component 110-1 displays graphical user interfaces enabling the user 101-1 to interact with system features. The interfaces include: a community search interface with search fields for entering criteria and display of search results, a network management interface showing connections 206 and directories with controls for adding, removing, and organizing contacts, a numbers interface showing assigned public 212 and private numbers 214 with configuration options, a lines interface showing active private lines 210 with status indicators and controls for managing lines, and a profile interface for configuring user settings and privacy controls.

### Server Application Features

In some embodiments, the server application components 108 (from FIG. 1) provide backend services for the client application components 110 (from FIG. 1). The server application components 108 are deployed on the central platform alongside the central controller 102 (from FIG. 1). The server application components 108 provide APIs that enable the client application components 110 to access functionality provided by the central controller 102.

The server application components 108 mediate between the client application components 110 and the central controller 102, providing protocol translation, authentication enforcement, request validation, and response formatting. The server application components 108 implement stateless services that are configured to be horizontally scaled to accommodate increasing numbers of concurrent users.

An API gateway routes requests from the client application components 110 to the appropriate server application components 108. The API gateway implements rate limiting, request logging, and security controls to protect the backend services from abuse or attack.

### Administration Interface Features

In some embodiments, the administration interface 106 (from FIG. 1) provides administrative features accessible to employer administrators 402 (from FIG. 4) and system administrators. The administration interface 106 is implemented as a portal accessible via web browsers. The portal includes authentication using administrator credentials and authorization controls limiting access to administrative functions based on administrator roles.

For employer administrators 402, the administration interface 106 provides features including: license pool management showing current license allocations and usage, license assignment to users enabling administrators to allocate licenses to specific users affiliated with the employer 404 (from FIG. 4), access control list management for configuring employer-level blocking and permit rules, default number visibility settings for users affiliated with the employer 404, and user management for viewing users affiliated with the employer 404 and their associated numbers and lines.

For system administrators, the administration interface 106 provides features including: employer onboarding for adding new employers 404 to the system 100 (from FIG. 1) and establishing license pools 406 (from FIG. 4), license pool management across all employers 404, system monitoring and health status, and configuration management for system-wide settings.

The following are additional clauses relative to the present disclosure, which could be combined and/or otherwise integrated with any of the embodiments described above or listed in the claims below.

### Connection Management Platform

Clause 1. A voice communication system comprising: a processor; and a memory storing instructions that, when executed by the processor, cause the system to: maintain a global directory of user identities, each user identity associated with a globally unique identifier; manage a plurality of connection types for establishing voice communications between users, the plurality of connection types including at least two of: dedicated private lines, public directory connections, temporary connection links, and dynamic routing paths; receive a connection request from a first user to establish voice communication with a second user; determine a connection type from the plurality of connection types based on at least one of: user preferences, connection permissions, or availability status; and establish the voice communication between the first user and the second user using the determined connection type.

Clause 2. The system of Clause 1, wherein the plurality of connection types includes dedicated private lines, public directory listings, and peer-to-peer connections.

Clause 3. The system of Clause 1, wherein determining the connection type comprises evaluating privacy settings, organizational relationships, or historical communication patterns between the first user and the second user.

Clause 4. The system of Clause 1, wherein the instructions further cause the system to provide a unified interface through which users manage multiple connection types simultaneously.

### Distributed Control Architecture

Clause 5. A voice communication system comprising: a distributed control system including a plurality of control modules that coordinate through inter-module communication protocols; wherein the plurality of control modules includes: a first control module configured to manage user authentication; a second control module configured to manage connection routing; and a third control module configured to manage resource allocation; wherein the distributed control system is configured to: receive connection requests from users; and coordinate among the plurality of control modules to establish voice connections based on user identity, routing requirements, and resource availability.

Clause 6. The system of Clause 5, wherein the distributed control system comprises core control services and edge processing components, with edge processing components configured to perform at least one of: presence updates, local routing decisions, or connection establishment.

Clause 7. The system of Clause 5, wherein the plurality of control modules are distributed across multiple geographic locations.

Clause 8. The system of Clause 5, wherein the inter-module communication protocols enable load balancing and redundancy across the plurality of control modules.

### Generalized Identity Framework

Clause 9. A method for managing voice communications comprising: assigning to each user a globally unique identifier, wherein the globally unique identifier comprises one of: a Uniform Resource Identifier (URI), an alphanumeric token, a cryptographic identifier, or a Universally Unique Identifier (UUID); maintaining a directory service that maps the globally unique identifier to user account information and connection endpoint information; receiving a connection request identifying a target user by their globally unique identifier; resolving the globally unique identifier to determine connection endpoint information for the target user; and establishing a voice connection to the target user based on the resolved connection endpoint information.

Clause 10. The method of Clause 9, wherein a user is associated with multiple globally unique identifiers of different formats, and wherein the method further comprises translating between identifier formats for directory lookup and connection establishment.

Clause 11. The method of Clause 9, wherein the globally unique identifier embeds at least one of: user identity information, connection type information, organization information, or routing information.

Clause 12. The method of Clause 9, wherein the directory service maintains mapping tables that associate identifier formats with user accounts, connection endpoints, and routing information.

### Intelligent Discovery and Routing

Clause 13. A voice communication system comprising: a processor; and a memory storing instructions that, when executed by the processor, cause the system to: maintain a directory of users available for voice connections; receive a search query from a requesting user; apply dynamic filtering to generate search results based on contextual factors including at least one of: user location, time of day, historical communication patterns, current availability status, or organizational relationships; calculate relevance scores for users in the search results based on a plurality of factors; and present the search results to the requesting user ranked according to the relevance scores.

Clause 14. The system of Clause 13, wherein the plurality of factors includes at least two of: frequency of prior communications, organizational proximity, shared group memberships, or complementary availability windows.

Clause 15. The system of Clause 13, wherein the instructions further cause the system to provide suggested connections to the requesting user based on analysis of the requesting user's communication network.

Clause 16. The system of Clause 13, wherein the instructions further cause the system to: identify multiple possible connection paths for establishing voice communication between two users; and dynamically select a connection path based on at least one of: quality metrics, cost optimization, privacy requirements, or predicted availability.

Clause 17. The system of Clause 13, wherein the dynamic filtering adapts based on learned user preferences over time.

### Flexible Resource Allocation

Clause 18. A voice communication system comprising: a processor; and a memory storing instructions that, when executed by the processor, cause the system to: associate users with service entitlements according to a resource allocation model, wherein the resource allocation model comprises at least one of: subscription-based access to service tiers, consumption-based charging according to usage metrics, capacity-based allocation of connection resources, or feature-based enablement of platform capabilities; receive a connection request from a user; verify that the user's service entitlements permit the connection request according to the resource allocation model; and establish a voice connection if the service entitlements permit the connection request.

Clause 19. The system of Clause 18, wherein the subscription-based access includes service tiers with combinations of features, connection types, or usage limits.

Clause 20. The system of Clause 18, wherein the consumption-based charging is based on at least one of: minutes consumed, connections established, or active users per billing period.

Clause 21. The system of Clause 18, wherein the capacity-based allocation includes at least one of: connection capacity limits, concurrent call limits, or bandwidth resource limits.

Clause 22. The system of Clause 18, wherein the feature-based enablement controls access to at least two of: private lines, public directory listing, intelligent routing, or application programming interface access.

Clause 23. The system of Clause 18, wherein different users within a single organization are associated with different resource allocation models.

While various example embodiments have been described above, it should be understood that they have been presented by way of example, and not limitation. It will be apparent to persons skilled in the relevant art(s) that various changes in form and detail can be made therein. Thus, the present embodiments should not be limited by any of the above described example embodiments, but should be defined only in accordance with the following claims and their equivalents.

In addition, it should be understood that the FIGS. 1-15 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for managing voice communications across a plurality of communication systems, the method comprising:
collecting, by one or more edge agents, user information from a plurality of communication systems;
transmitting, by the one or more edge agents, the user information to a central controller;
adding, by the central controller, users to a community maintained in a consolidated database based on the user information;
automatically assigning, by the central controller, unique identifiers to each user, wherein each unique identifier comprises an application prefix, a system identifier, a number type indicator, and a user number;
provisioning, by the one or more edge agents, extensions in the plurality of communication systems corresponding to the user numbers; and
provisioning, by the one or more edge agents, resource buttons in user interfaces to enable users to receive incoming calls on the extensions.

2. The method of claim 1, further comprising:
receiving, by the central controller, a search request from a first user to search the community;
querying, by the central controller, the consolidated database for contact records matching search criteria in the search request;
returning, by the central controller, search results filtered based on privacy settings; and
receiving, by the central controller, a selection of a second user from the search results.

3. The method of claim 2, further comprising:
receiving, by the central controller, a call initiation request from the first user to call the second user;
transmitting, by the central controller, a computer telephony integration call request to an edge agent associated with the first user;
generating, by a communication system associated with the first user, an outgoing call using a unique identifier assigned to the second user; and
establishing a voice connection between the first user and the second user.

4. The method of claim 1, further comprising:
monitoring, by the one or more edge agents, presence information indicating whether users are logged into turrets;
determining, by the one or more edge agents, turret types for logged-in users;
transmitting, by the one or more edge agents, real-time presence updates to the central controller; and
distributing, by the central controller, the presence updates to client application components for display via presence indicators.

5. The method of claim 4, wherein the presence indicators display one or more of: whether a user is logged into a turret, a type of turret the user is logged into, and whether the user is currently busy on an active call.

6. The method of claim 1, further comprising:
receiving, by the central controller, visibility settings from users, each visibility setting defining access restrictions for assigned numbers;
enforcing, by the central controller, privacy policies based on the visibility settings;
publishing public numbers in a global community directory; and
excluding private numbers from the global community directory.

7. The method of claim 6, wherein enforcing privacy policies comprises:
applying default permit behavior for public numbers such that all calls are permitted unless a blocking rule is applied; and
applying default deny behavior for private numbers such that all calls are denied unless a permit rule is applied.

8. The method of claim 6, further comprising:
receiving, by the central controller, a blocking rule from a user identifying one or more numbers to block;
updating, by the central controller, access control lists in the consolidated database; and
transmitting, by the central controller, the access control lists to communication systems to reject calls from blocked numbers.

9. The method of claim 1, further comprising:
managing, by the central controller, routing rules for a plurality of communication systems;
extracting, by one of the communication systems, a calling number and a called number from call signaling for an incoming call;
querying, by the communication system, access control rules associated with the called number;
determining, by the communication system, whether to permit or deny the incoming call based on the access control rules and the number type indicator; and
routing or rejecting, by the communication system, the incoming call based on the determination.

10. The method of claim 9, wherein the number type indicator identifies the called number as one of: a public number, a private number, or a private line endpoint.

11. The method of claim 1, further comprising:
receiving, by the central controller, a private line request from a first user specifying a second user as a counterparty;
creating, by the central controller, a private line record in the consolidated database indicating a pending state;
transmitting, by the central controller, an acceptance request to the second user;
receiving, by the central controller, acceptance of the private line request from the second user;
initiating, by the central controller, provisioning of the private line in response to the acceptance;
generating, by the central controller, a unique connection number for the private line;
orchestrating, by the central controller, provisioning of private line extensions at both endpoints via edge agents;
provisioning, by the central controller, call screening rules in communication systems to block calls from numbers other than designated counterparty endpoints;
receiving, by the central controller, provisioning completion notifications from the edge agents and the communication systems; and
updating, by the central controller, the private line record to indicate the private line is active when all provisioning is complete.

12. The method of claim 11, wherein the private line record comprises: a from-end enterprise identifier, a from-end user identifier, a from-end location, a from-end system identifier, a to-end enterprise identifier, a to-end user identifier, a to-end location, a to-end system identifier, the unique connection number, the status, provisioning state flags, and a request date.

13. The method of claim 11, further comprising:
receiving, by the central controller, a deletion request for the private line from one of the first user or the second user;
initiating, by the central controller, removal of the private line extensions at both endpoints;
orchestrating, by the central controller, deprovisioning of the private line extensions through the edge agents;
receiving, by the central controller, completion notifications from the edge agents; and
updating, by the central controller, the private line record to indicate the private line has been removed.

14. The method of claim 1, further comprising:
managing, by the central controller, license pools associated with employers;
assigning, by the central controller, licenses to users from the license pools, wherein the licenses comprise number licenses authorizing private numbers and line licenses authorizing private lines;
receiving, by the central controller, a request to provision a private number or a private line for a user;
verifying, by the central controller, that the user has an available license of the appropriate type; and
provisioning the private number or the private line only if the license is available.

15. The method of claim 1, further comprising:
managing, by the central controller, team numbers associated with multiple users who are members of a team;
configuring, by the central controller, the team numbers to be accessible to all team members; and
provisioning, by edge agents, extensions and buttons for the team numbers to enable all team members to receive calls on the team numbers.

16. The method of claim 1, further comprising:
provisioning, by the central controller, virtual speed-dial links comprising dedicated back-to-back numbers configured as dedicated speed-dials between users;
configuring, by the central controller, communication systems to permit calls between the back-to-back numbers only when originated from counterparty endpoints; and
blocking, by the communication systems, any calls to the dedicated back-to-back numbers from numbers other than the designated counterparties.

17. The method of claim 1, further comprising:
maintaining, by the one or more edge agents, local databases storing user information and presence data;
detecting, by an edge agent, connectivity between the edge agent and the central controller being temporarily interrupted;
continuing, by the edge agent, to provide local presence monitoring and service requests using the local database during the temporarily interrupted connectivity;
detecting, by the edge agent, restoration of connectivity to the central controller; and
synchronizing, by the edge agent, with the central controller to update changes that occurred during the temporarily interrupted connectivity.

18. The method of claim 1, further comprising:
implementing, by communication systems, call admission control by limiting concurrent calls to a particular number based on configured maximum concurrent call limits;
receiving, by a communication system, an incoming call to a called number;
querying, by the communication system, a current number of active calls for the called number;
determining, by the communication system, whether the current number of active calls equals or exceeds the maximum concurrent call limit; and
rejecting, by the communication system, the incoming call if the maximum concurrent call limit is reached.

19. A non-transitory computer-readable medium storing instructions that, when executed by one or more processors, cause the one or more processors to perform operations comprising:
collecting user information from a plurality of communication systems via one or more edge agents;
receiving the user information at a central controller from the one or more edge agents;
adding users to a community maintained in a consolidated database based on the user information;
automatically assigning unique identifiers to each user, wherein each unique identifier comprises an application prefix, a system identifier, a number type indicator, and a user number;
provisioning extensions in the plurality of communication systems corresponding to the user numbers via the one or more edge agents; and
provisioning resource buttons in user interfaces to enable users to receive incoming calls on the extensions via the one or more edge agents.

20. A voice communication system comprising:
a central controller configured to:
receive user information from one or more edge agents;
add users to a community maintained in a consolidated database based on the user information;
automatically assign unique identifiers to each user, wherein each unique identifier comprises an application prefix, a system identifier, a number type indicator, and a user number; and
coordinate provisioning of extensions and resource buttons via the one or more edge agents;
the one or more edge agents configured to:
collect user information from a plurality of communication systems via communication system interfaces;
transmit the user information to the central controller;
provision extensions in the plurality of communication systems corresponding to the user numbers; and
provision resource buttons in user interfaces to enable users to receive incoming calls on the extensions;
wherein the plurality of communication systems are configured to route communications between users based on the unique identifiers assigned by the central controller.
